(19) United States
(12) Patent Application Publication
(10) Pub. No.: US 2011/0082702 A1
(43) Pub. Date: Apr. 7, 2011

(54) TELEPHONE INTERVIEW EVALUATION METHOD AND SYSTEM

(76) Inventor: Paul Bailo, Trumbull, CT (US)

(21) Appl. No.: 12/768,720

(22) Filed: Apr. 27, 2010

Related U.S. Application Data
(60) Provisional application No. 61/214,555, filed on Apr. 27, 2009.

(51) Int. Cl. G06Q 99/00

(52) U.S. Cl. 705/1.1

(57) ABSTRACT

A method and system for evaluating the telephone interview behavior of a job applicant includes a live telephone interview between the job applicant and a trained evaluator asking questions and recording verbal and non verbal responses. The questions are designed to test and probe certain important behaviors and the evaluator submits his report to an electronic algorithm acting in concert with a historical database. The algorithm generates a report on multiple important parameters and said report is communicated back to the job applicant for feedback and self evaluation.

### CROSS REFERENCES TO RELATED APPLICATIONS

This non-provisional patent application claims a priority benefit to US Provisional Application No. 61,214,555 entitled “TELEPHONE INTERVIEW EVALUATION METHOD AND SYSTEM” filed in the United States Patent and Trademark Office on Apr. 27, 2009 by a common Inventor to this instant application, Paul Bailo.

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to interviewing methods and systems, and more particularly to a method and system for evaluating the telephone behavior of a job applicant in a simulated interview, recording the applicant's responses to specific questions, processing the responses through a proprietary computer algorithm and database, scoring the applicant's interview and reporting same to the applicant as feedback for improvement and or self awareness.

### SUMMARY OF THE INVENTION

The telephone interview evaluation method and system leverages scientific research and a mathematical algorithm to determine:

Probability of the Applicant being recommended to the hiring manager;

Probability of Applicant obtaining a face to face meeting with a prospective employer;

A Benchmark of the Applicant's performance against his peers;

Applicant's response to over 250 phone interviewing dimensions;

An evaluation of each of the Applicant's responses; and

A detailed report as feedback to the applicant.

Every aspect of the phone interview is evaluated including applicant's preparation, interviewing skills, and applicant's closing behavior.

The advantages and features discussed above and other advantages and features will become apparent from the detailed description of the best mode for carrying out the invention that follows.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a computer screen shot of the login page of the invention;

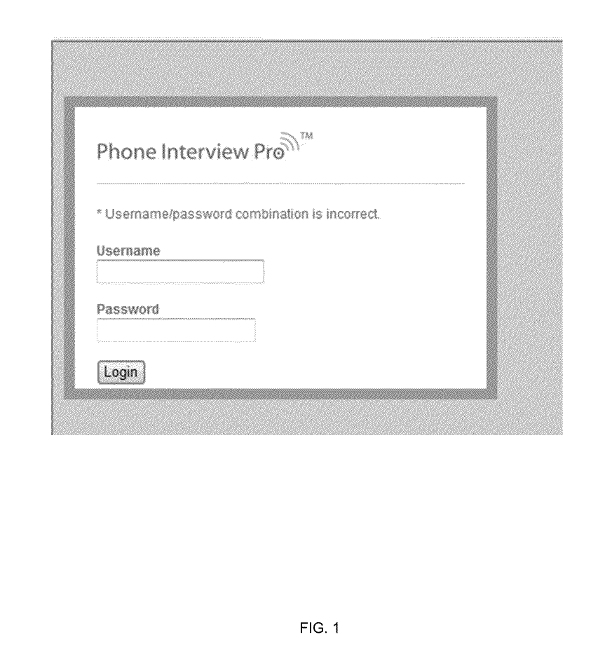

FIG. 2 is a computer screen shot of the client information page;

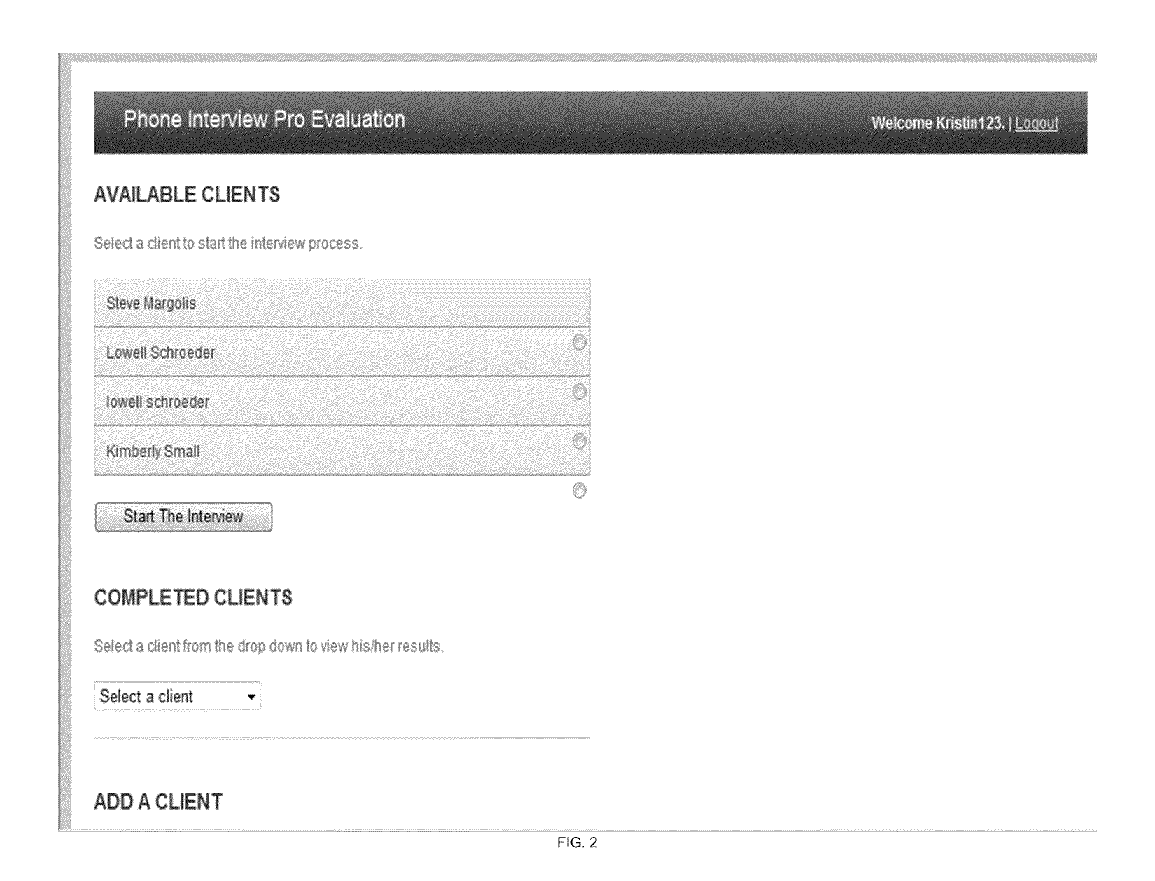

FIG. 3 is a computer screen shot of a client rating page;

FIG. 4 is a computer screen shot of a first interview question and responses;

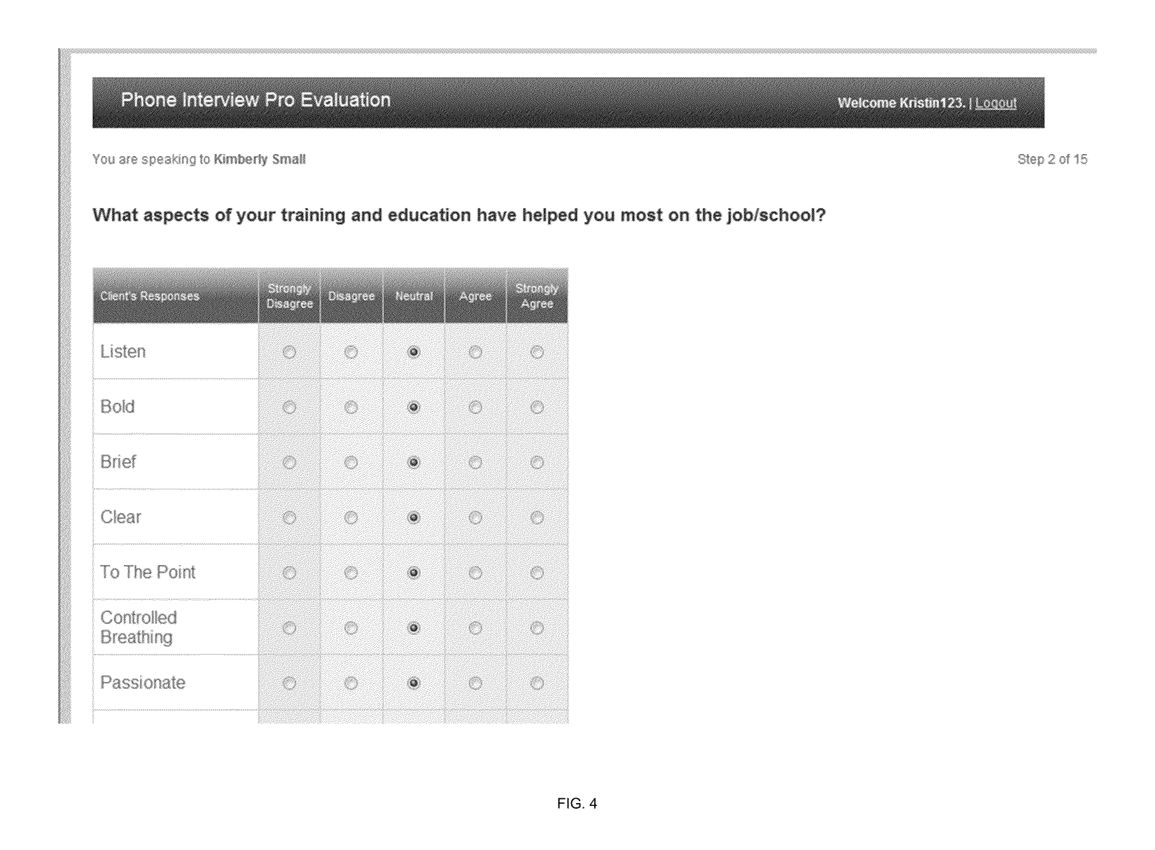

FIG. 5 is a computer screen shot of a second client response page;

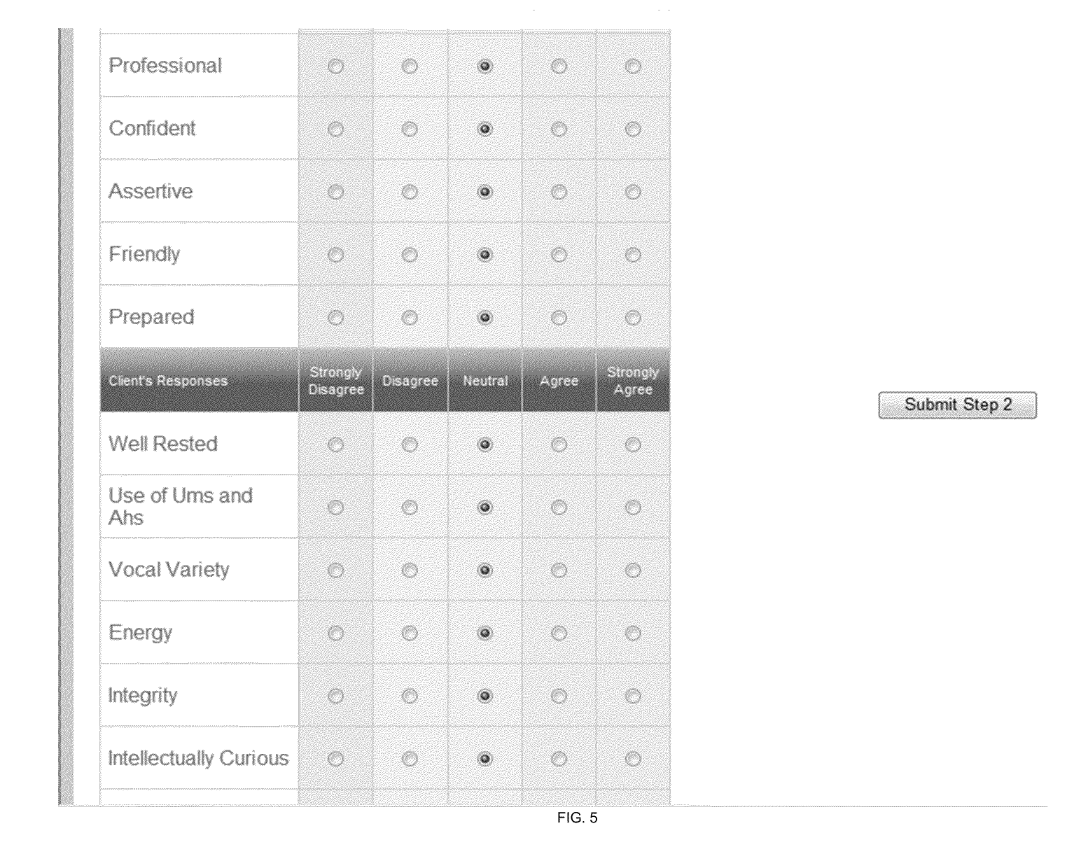

FIG. 6 is a computer screen shot of a third client response page;

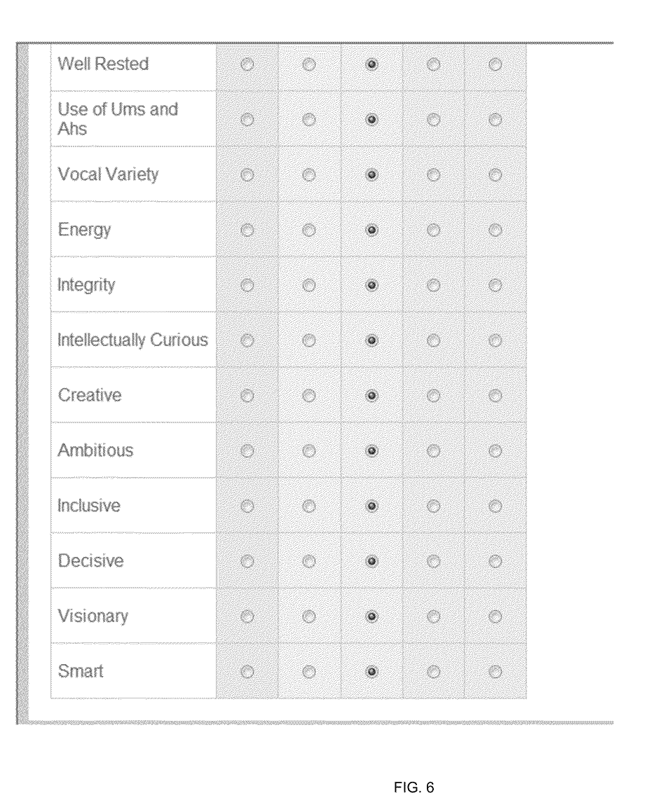

FIG. 7 is a computer screen shot of a forth client response page;

FIG. 8 is a computer screen shot of a second interview question and responses;

FIG. 9 is a computer screen shot of a second client response page;

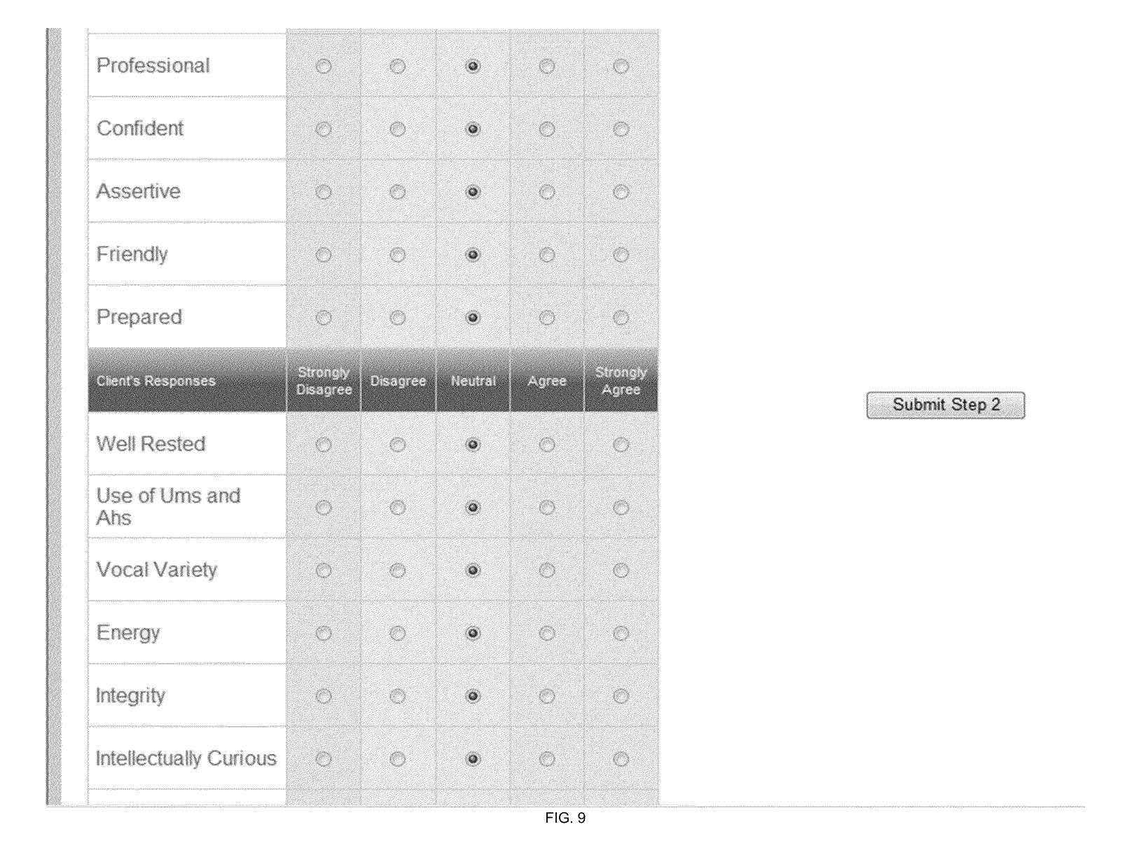

FIG. 10 is a computer screen shot of a third client response page;

FIG. 11 is a computer screen shot of a third interview question and responses;

FIG. 12 is a computer screen shot of a second client response page;

FIG. 13 is a computer screen shot of a third client response page;

FIG. 14 is a computer screen shot of a fourth interview question and responses;

FIG. 15 is a computer screen shot of a second client response page;

FIG. 16 is a computer screen shot of a third client response page;

FIG. 17 is a computer screen shot of a fifth interview question and responses;

FIG. 18 is a computer screen shot of a second client response page;

FIG. 19 is a computer screen shot of a third client response page;

FIG. 20 is a computer screen shot of a sixth interview question and responses;

FIG. 21 is a computer screen shot of a second client response page;

FIG. 22 is a computer screen shot of a third client response page;

FIG. 23 is a computer screen shot of a seventh interview question and responses;

FIG. 24 is a computer screen shot of a second client response page;

FIG. 25 is a computer screen shot of a third client response page;

FIG. 26 is a computer screen shot of a client interview closing actions;

FIG. 27 is a computer screen shot of a client human characters exhibited;

FIG. 28 is a computer screen shot of a second client human characters response page;

FIG. 29 is a computer screen shot of a third client human characters response page;

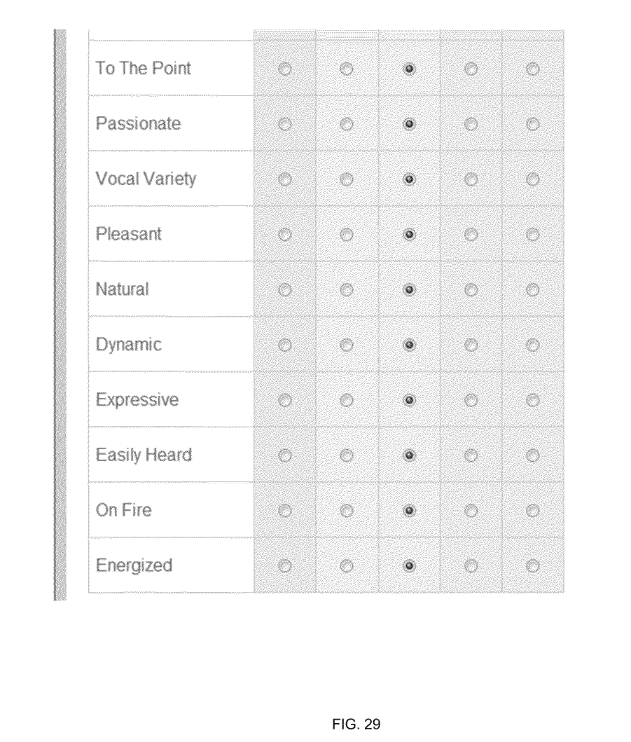

FIG. 30 is a computer screen shot of recommendations for client improvements;

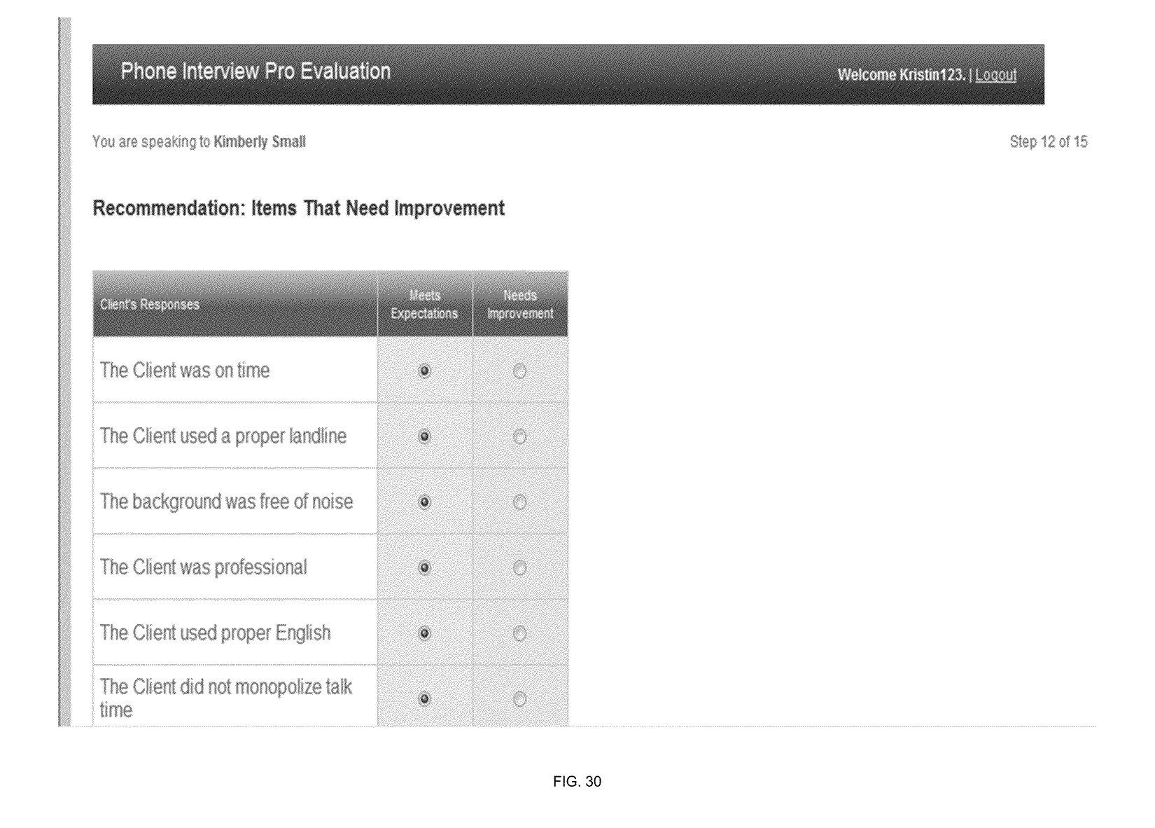

FIG. 31 is a computer screen shot of a second page of recommendations for client improvements;

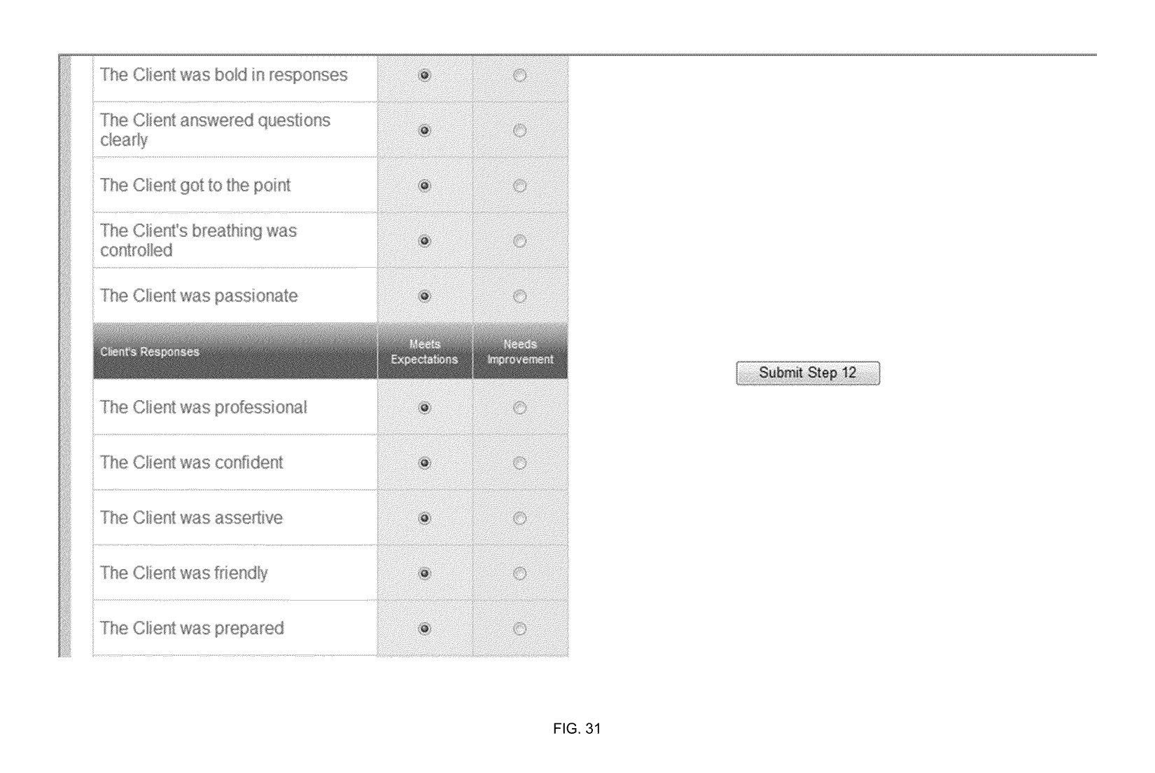

FIG. 32 is a computer screen shot of a third page of recommendations for client improvements;

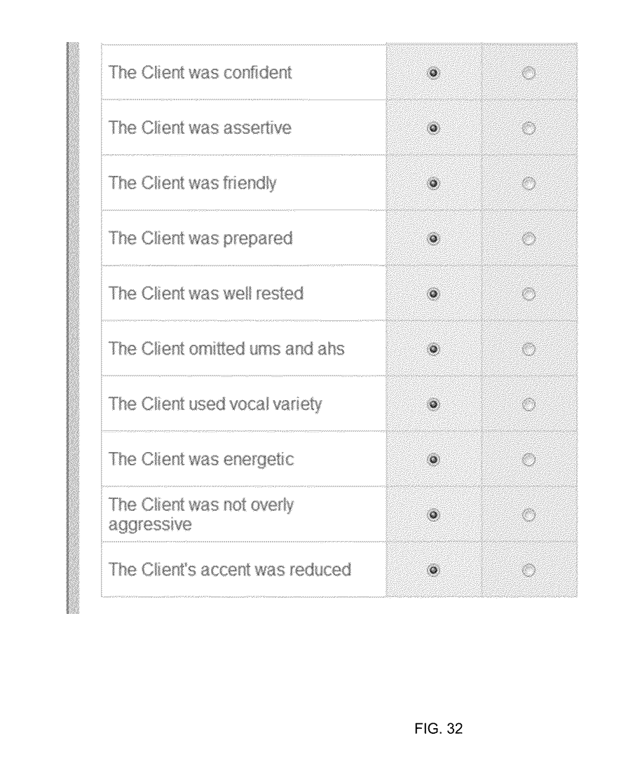

FIG. 33 is a computer screen shot of client strengths;

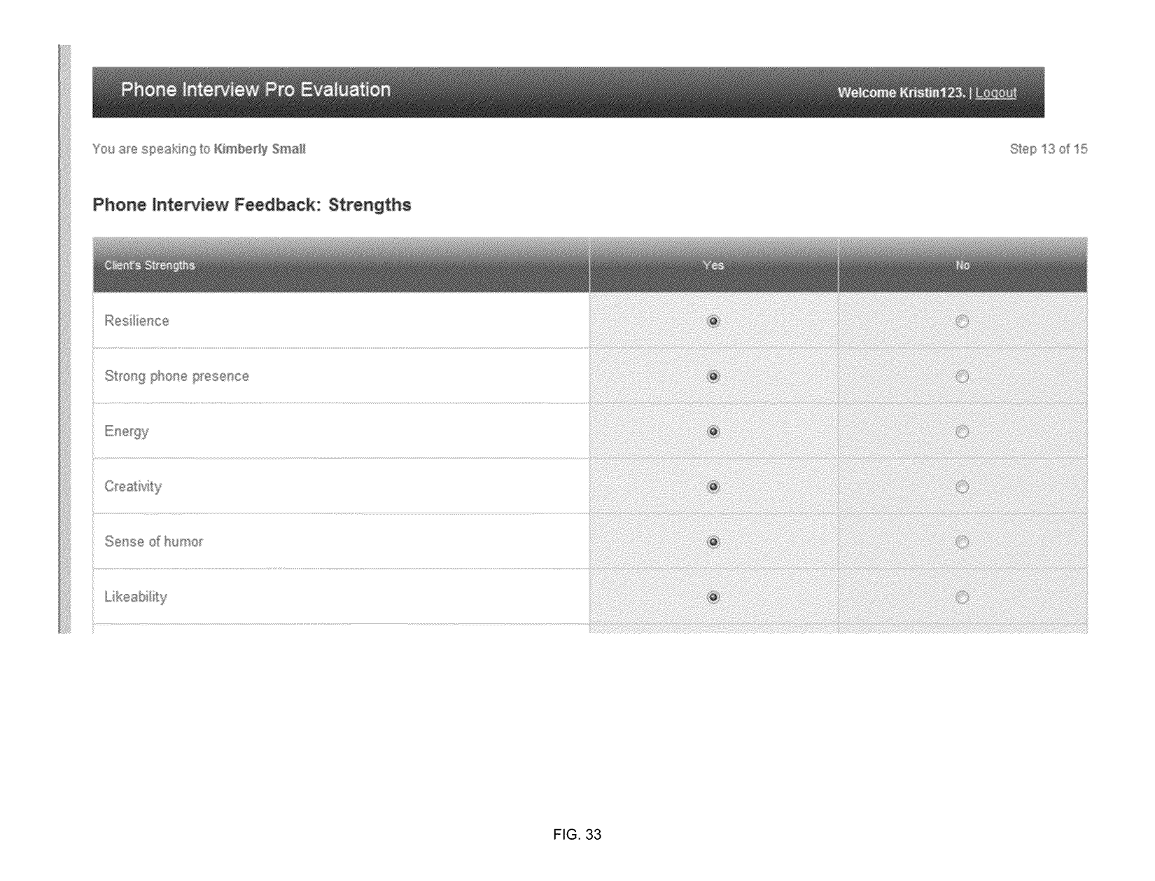

FIG. 34 is a computer screen shot of a second page of client strengths;

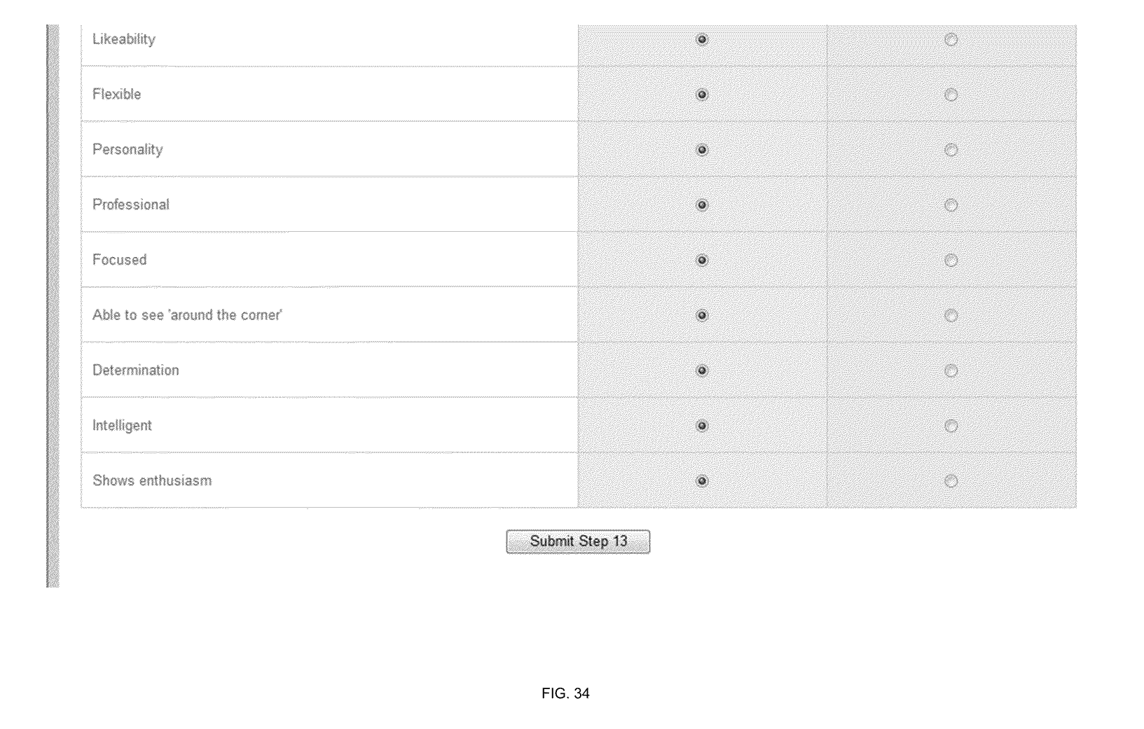

FIG. 35 is a computer screen shot of client weaknesses;

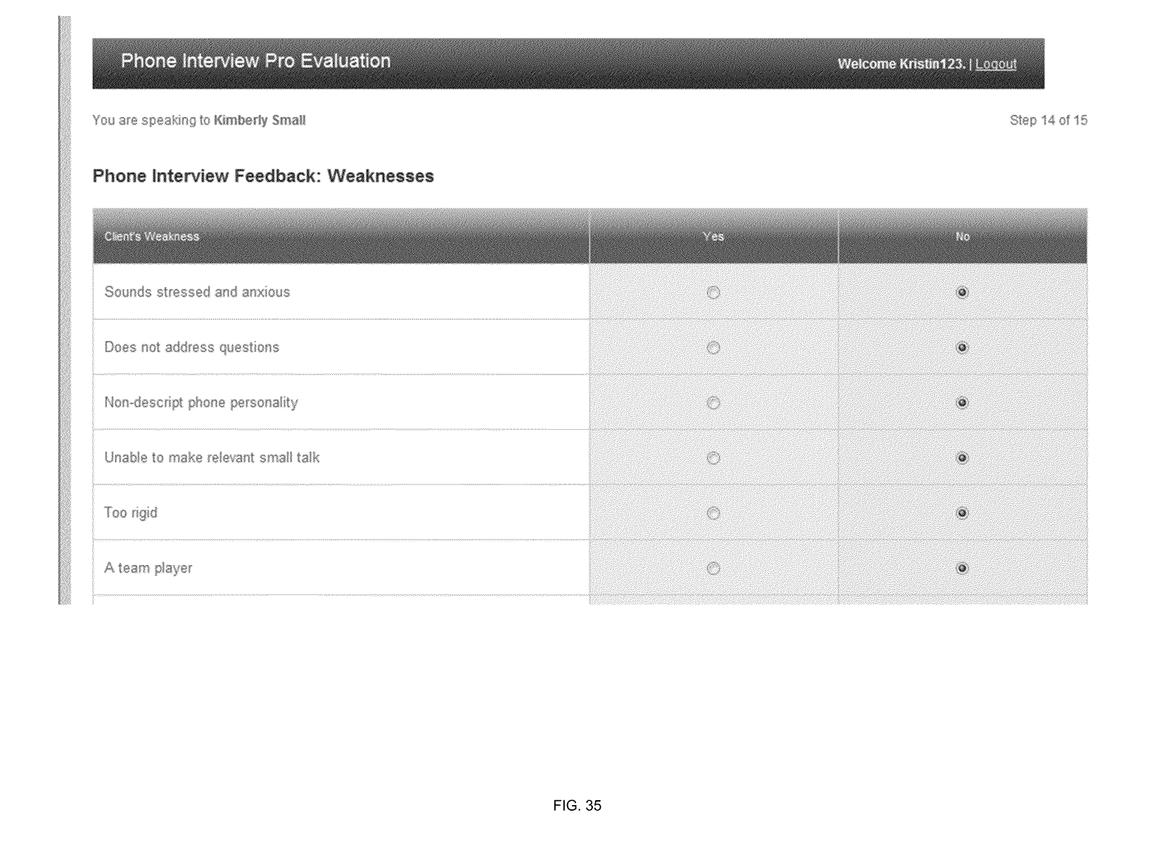

FIG. 36 is a computer screen shot of a second page of client weaknesses;

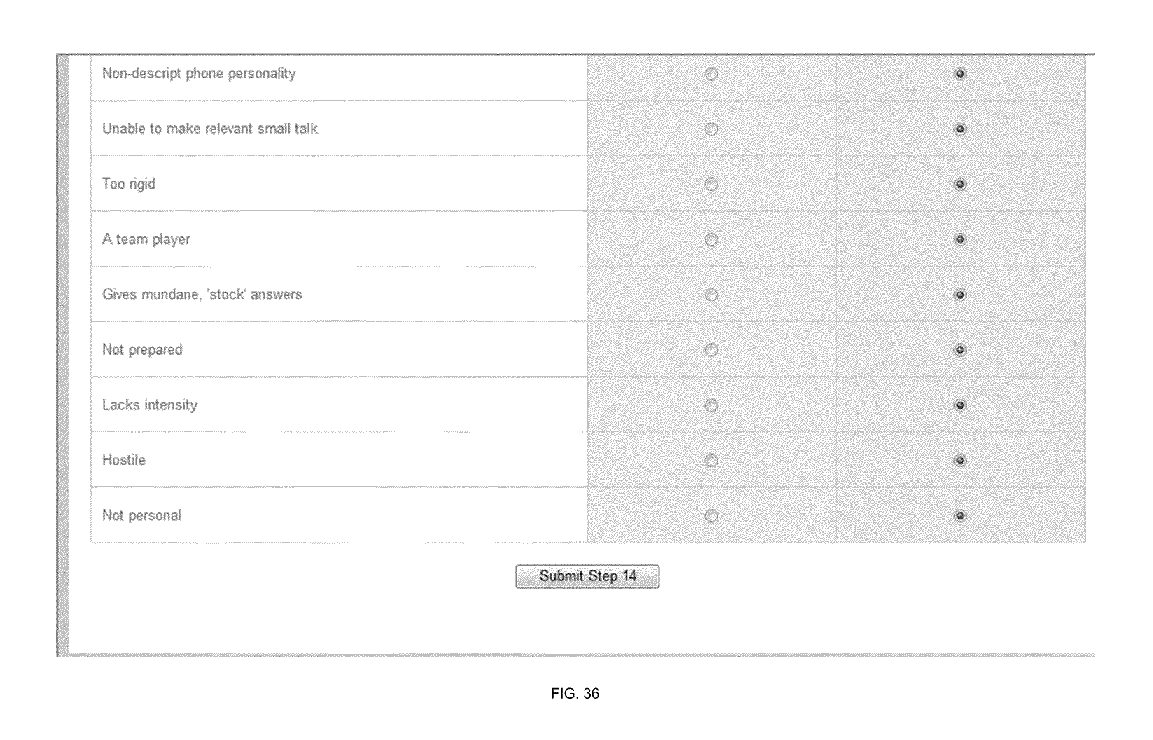

FIG. 37 is a computer screen shot of a client's overall phone interview rating;

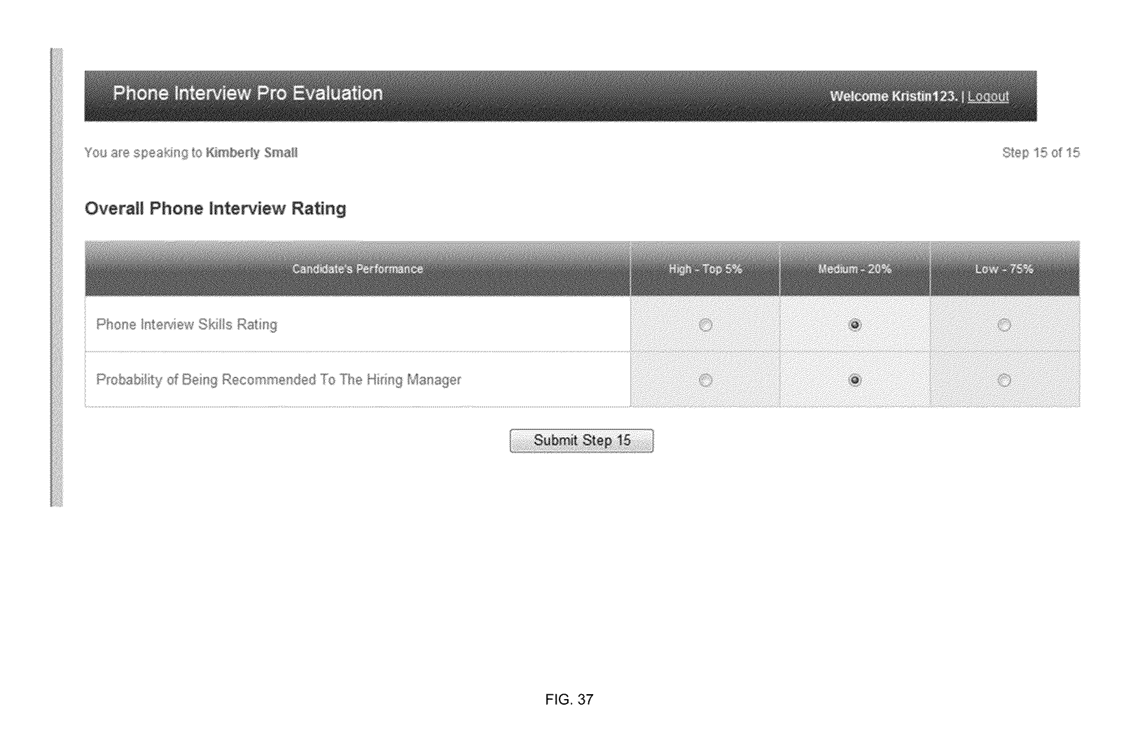

FIG. 38 is a computer screen shot of a client's title page for his evaluation report;

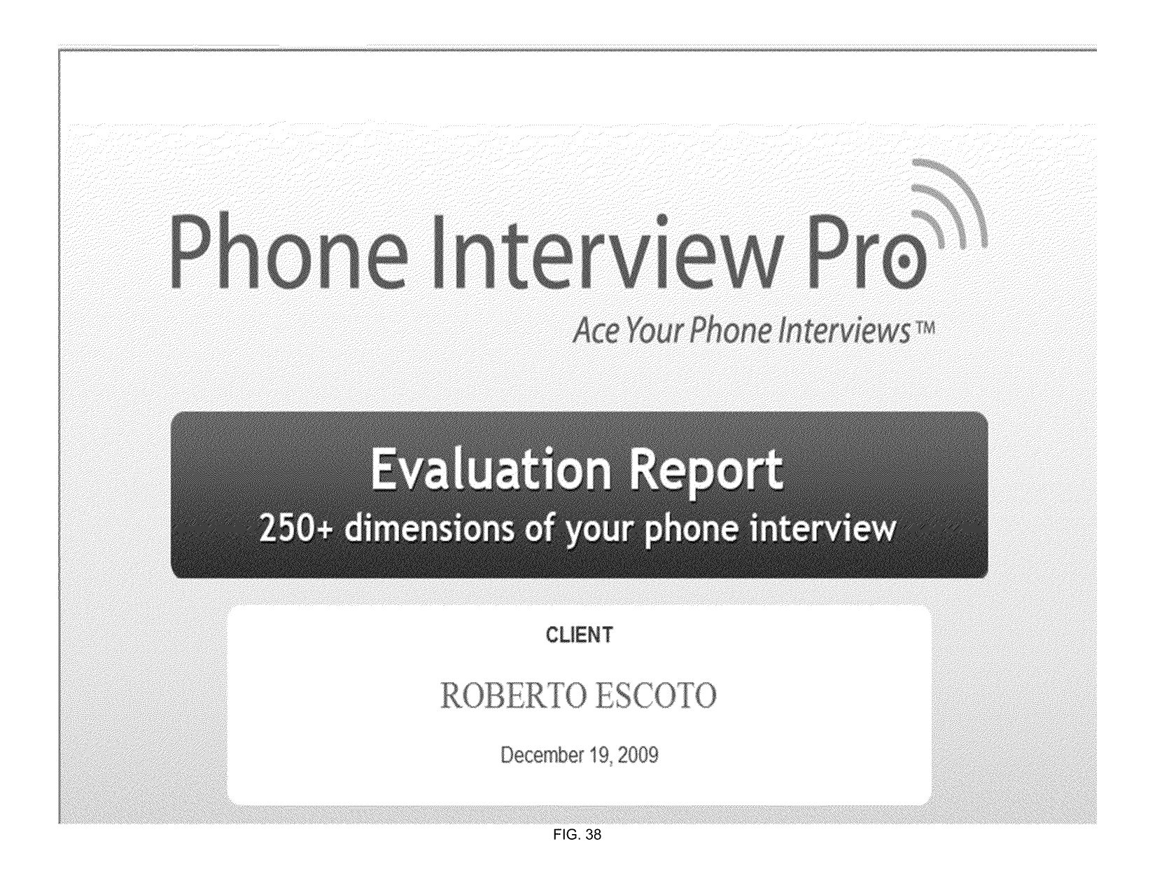

FIG. 39 is a computer screen shot of an introduction page to the evaluation report;

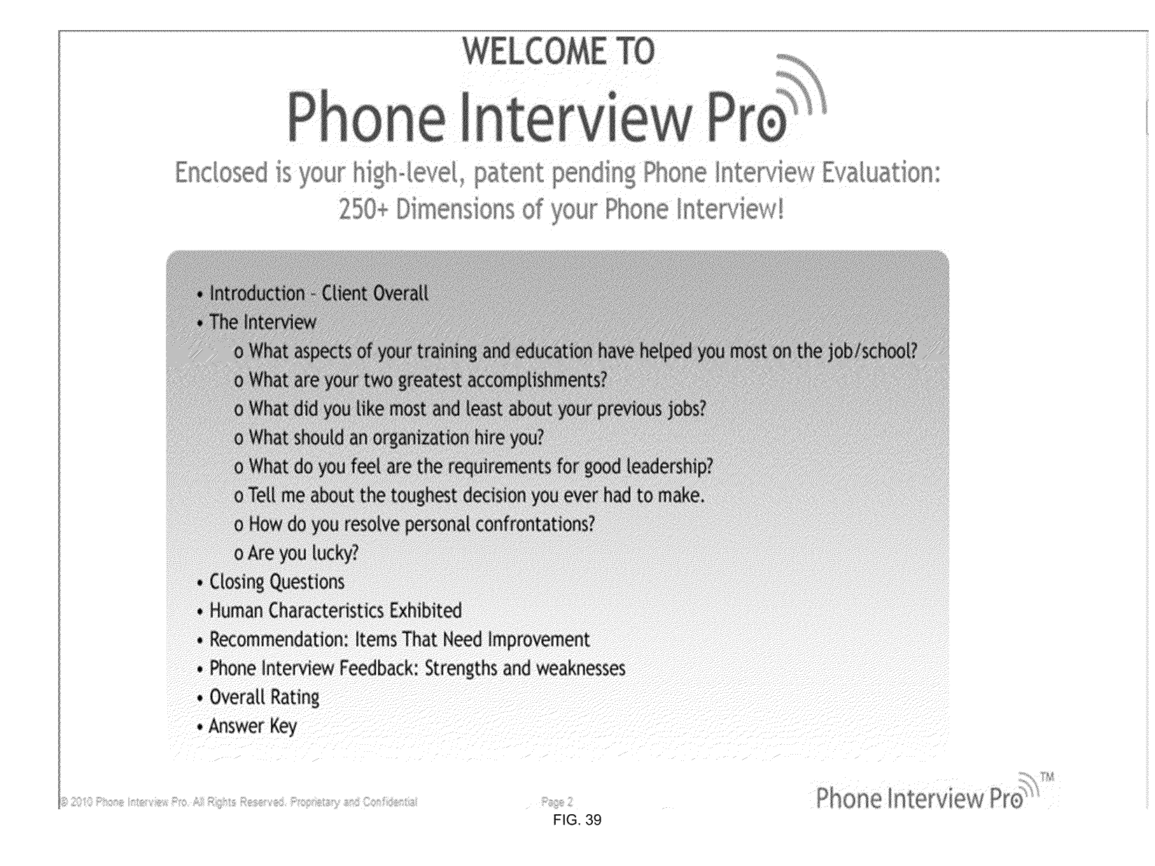

FIG. 40 is a computer screen shot of a client rating page in the evaluation report;

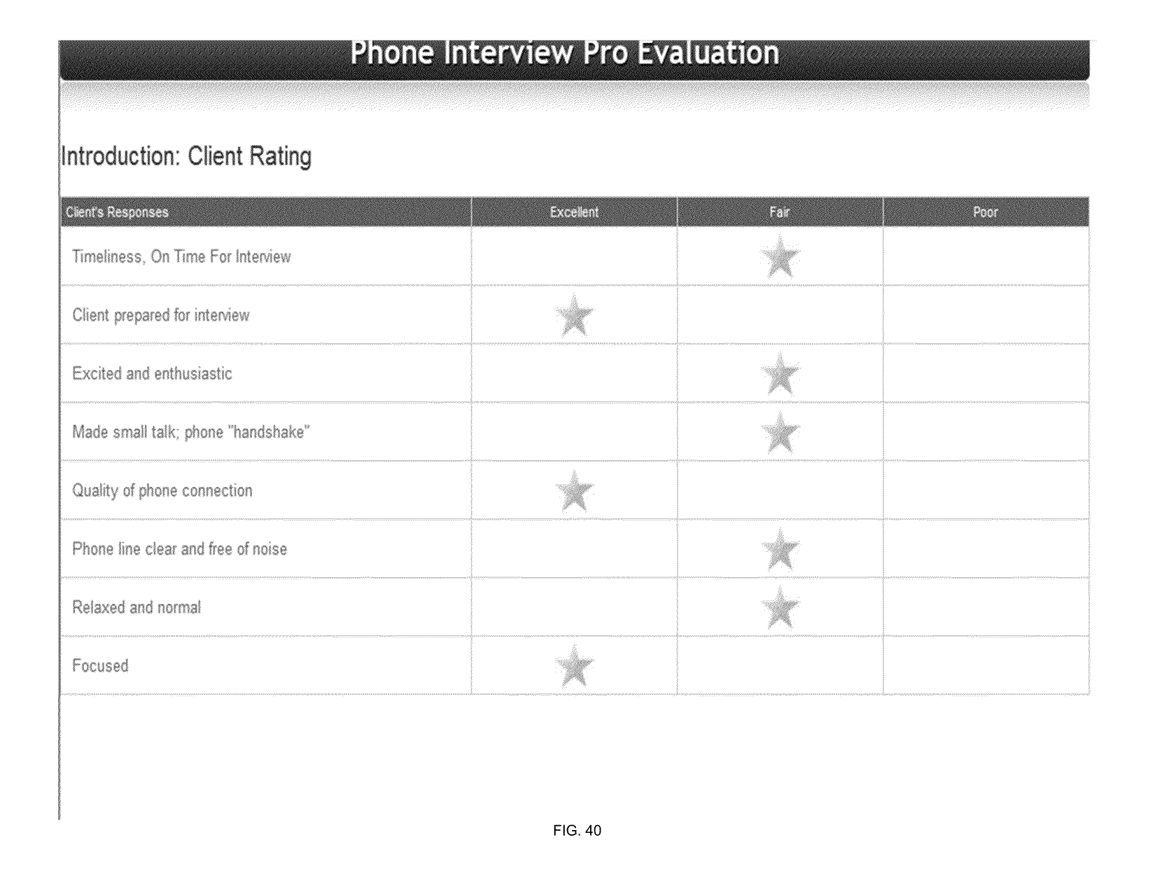

FIG. 41 is a computer screen shot of a client training/education page in the evaluation report;

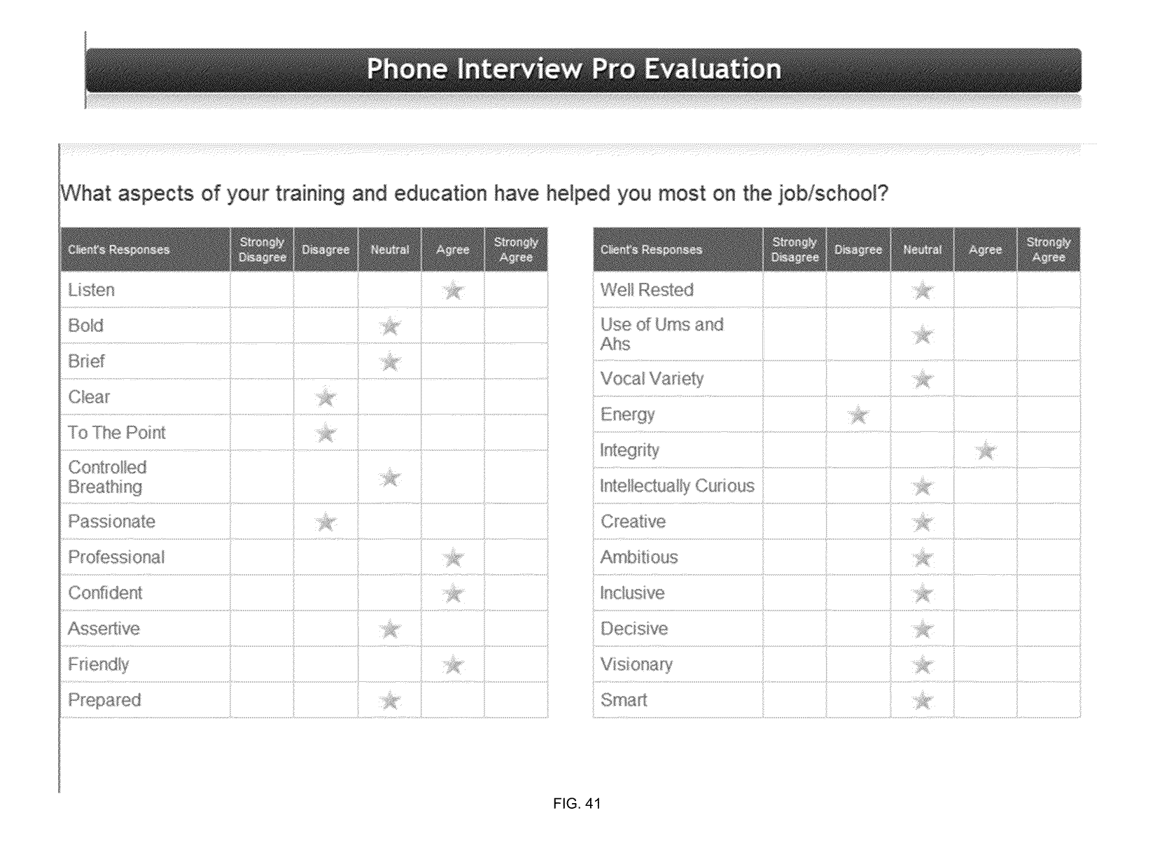

FIG. 42 is a computer screen shot of a client's greatest accomplishments page in the evaluation report;

FIG. 43 is a computer screen shot of a client's previous job likes/dislikes page in the evaluation report;

FIG. 44 is a computer screen shot of a client's reasons a company should hire him page in the evaluation report;

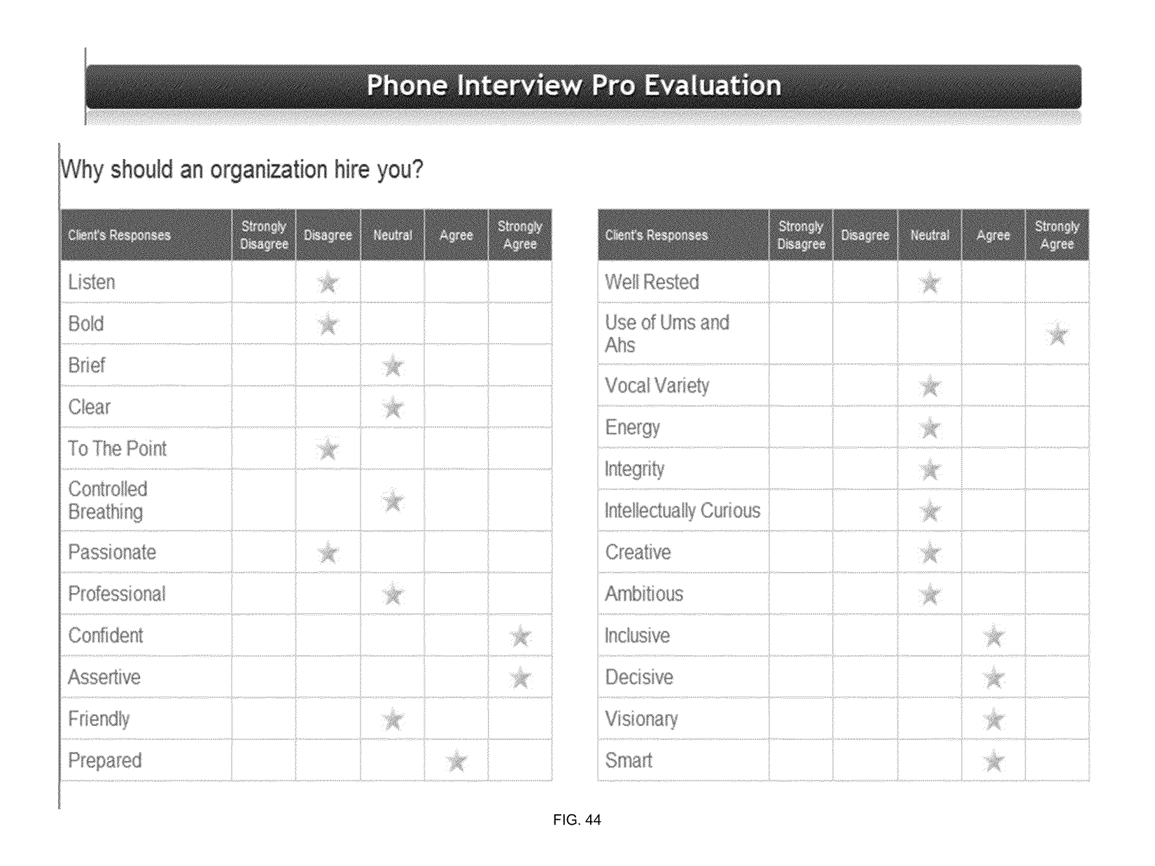

FIG. 45 is a computer screen shot of a client's requirements for good leadership page in the evaluation report;

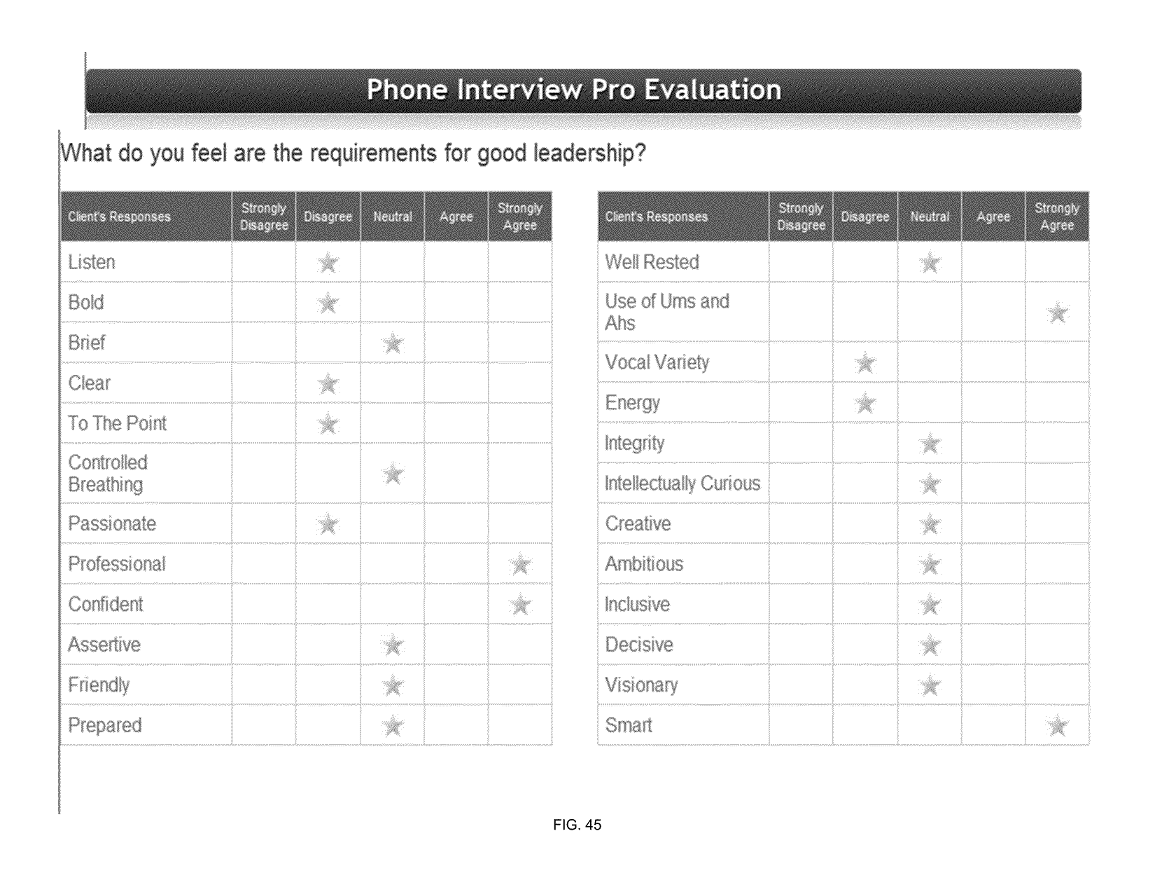

FIG. 46 is a computer screen shot of a client's toughest decision ever made page in the evaluation report;

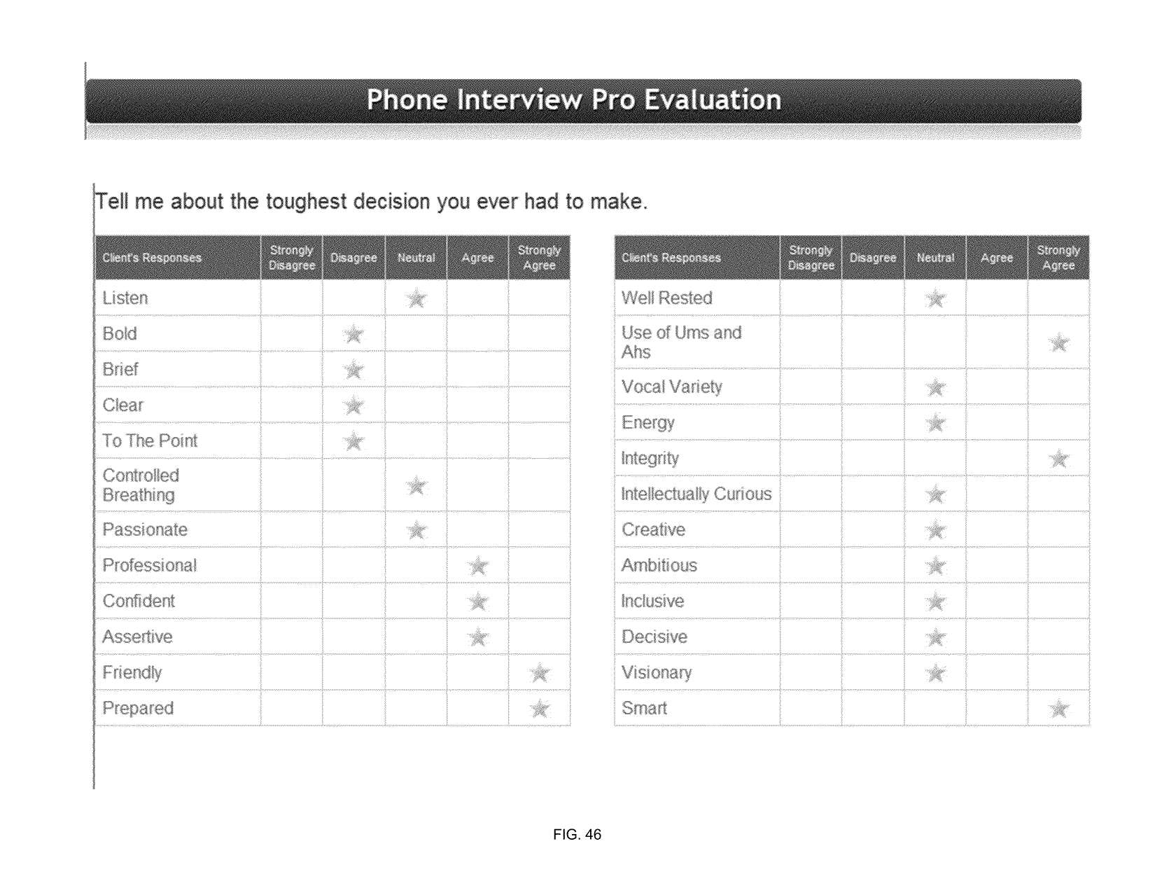

FIG. 47 is a computer screen shot of a client's methods for resolving personal confrontations page in the evaluation report;

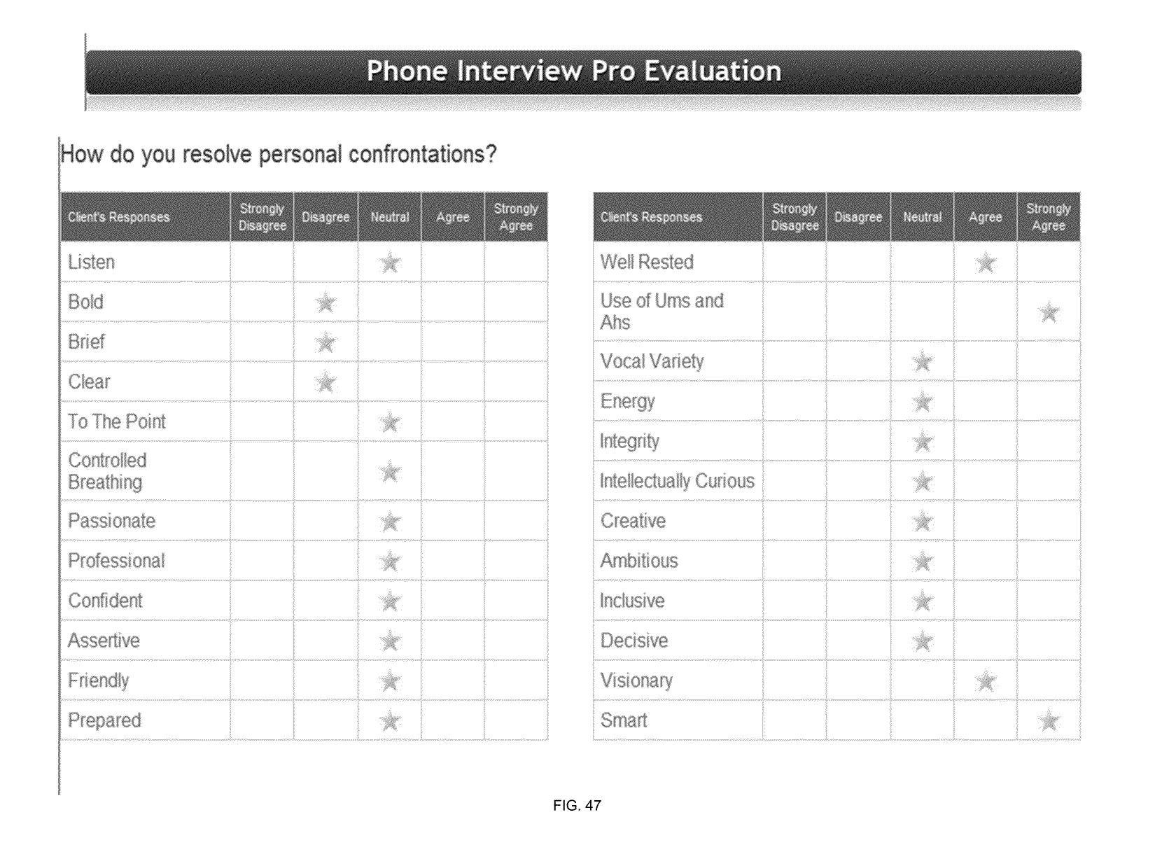

FIG. 48 is a computer screen shot of a client's belief as to his luck page in the evaluation report;

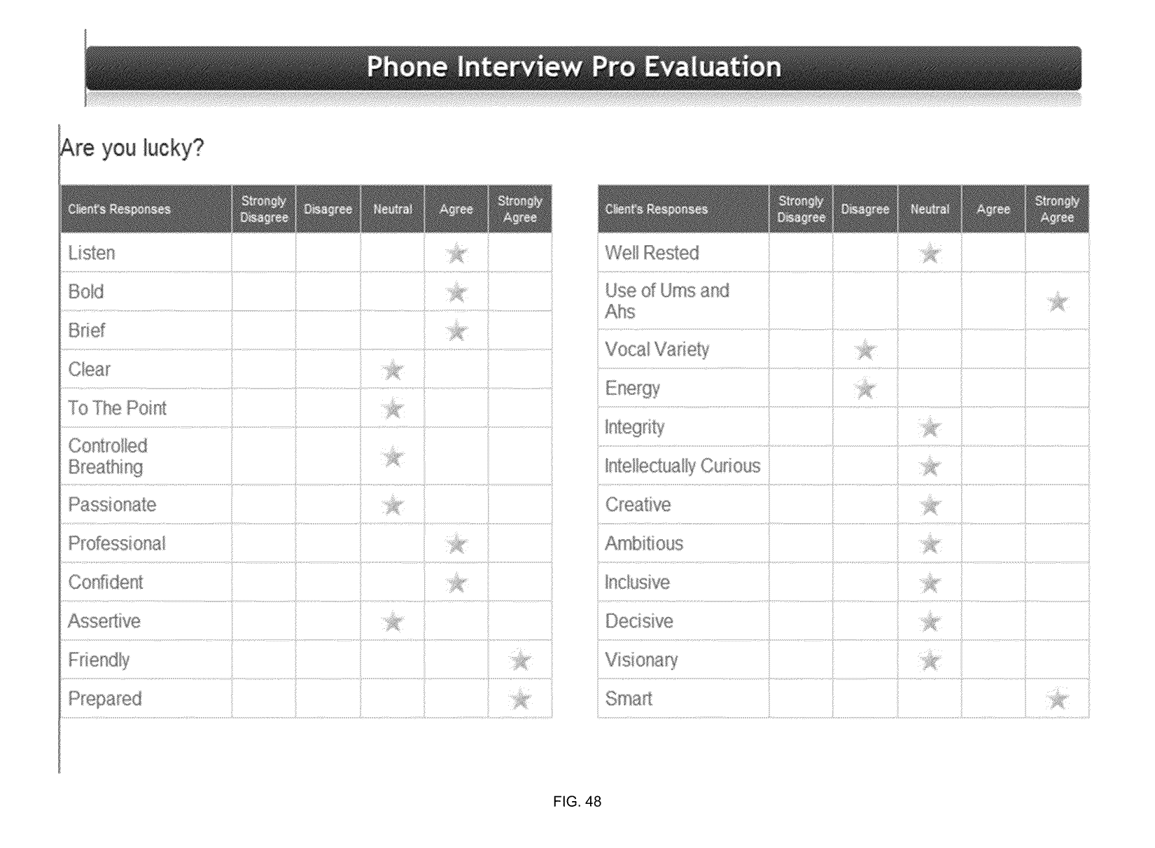

FIG. 49 is a computer screen shot of a client's top three actions page in the evaluation report;

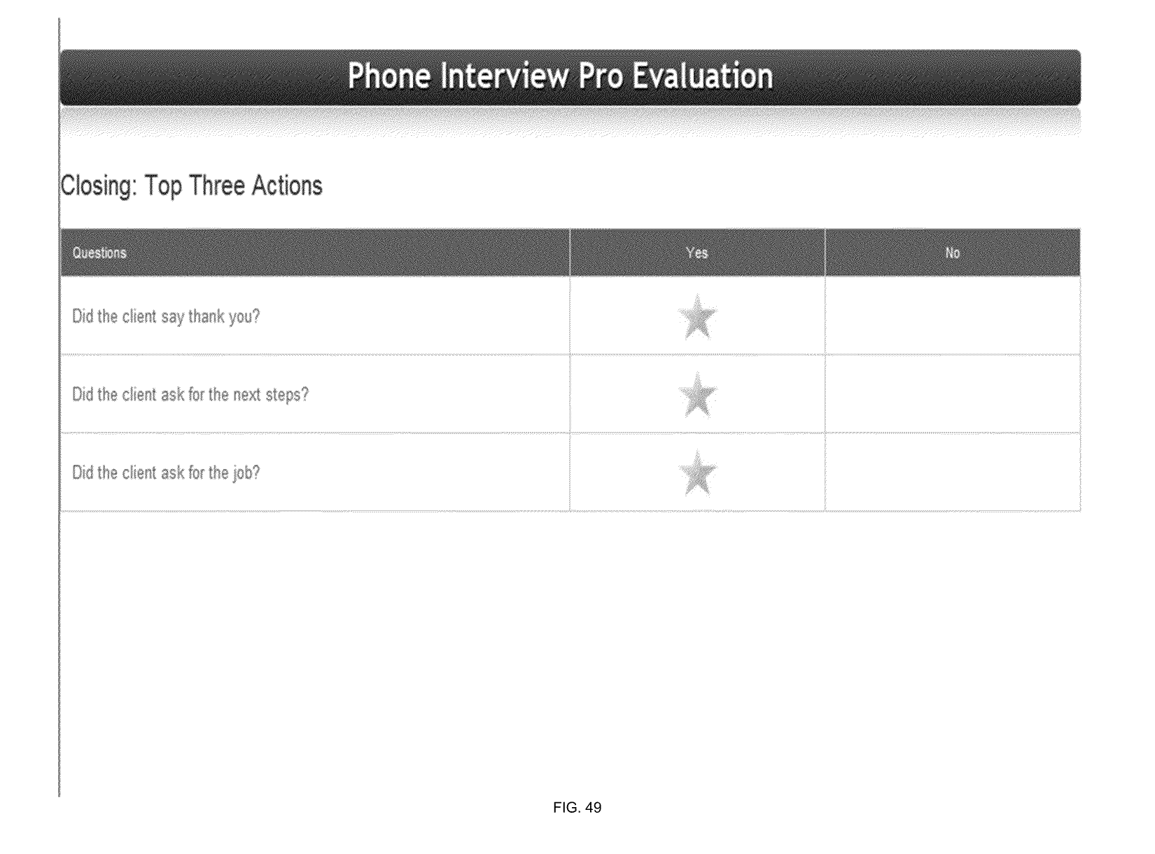

FIG. 50 is a computer screen shot of a client's human characters exhibited page in the evaluation report;

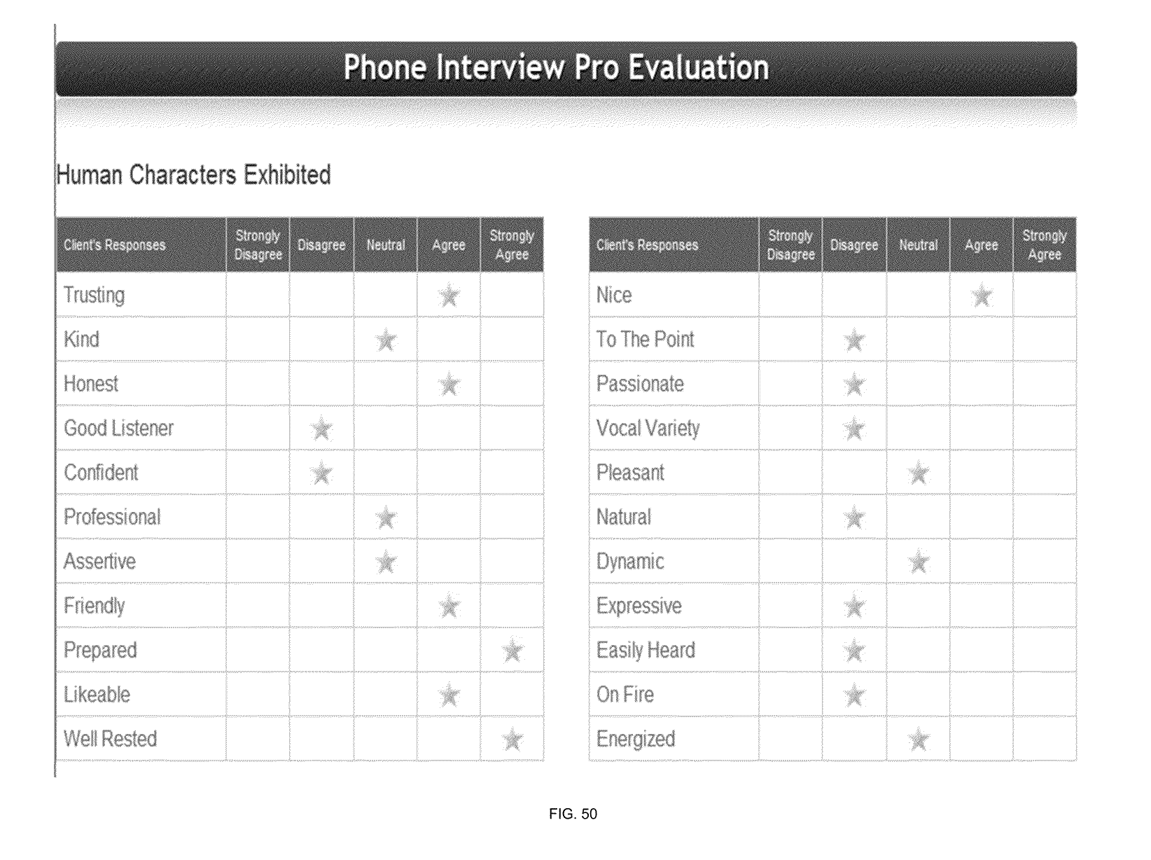

FIG. 51 is a computer screen shot of recommendations to the client for improvement page in the evaluation report; and

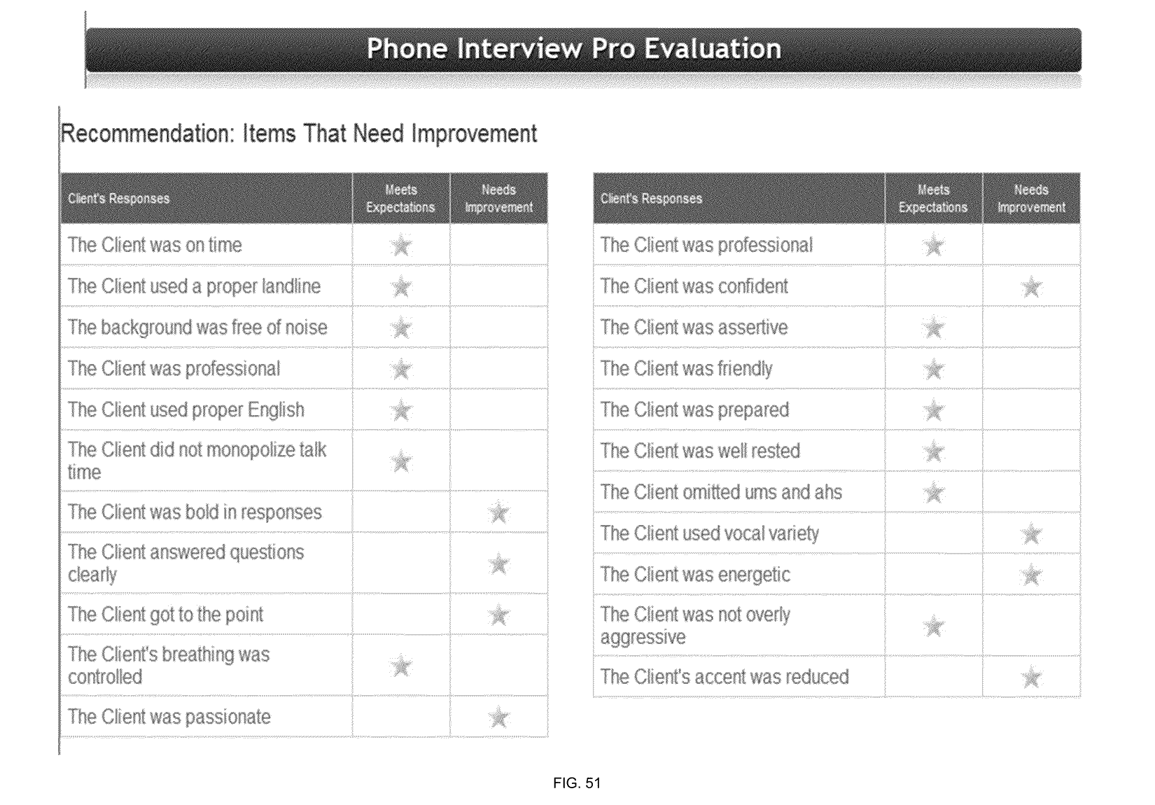

FIG. 52 is a computer screen shot of a client's interview strengths page in the evaluation report.

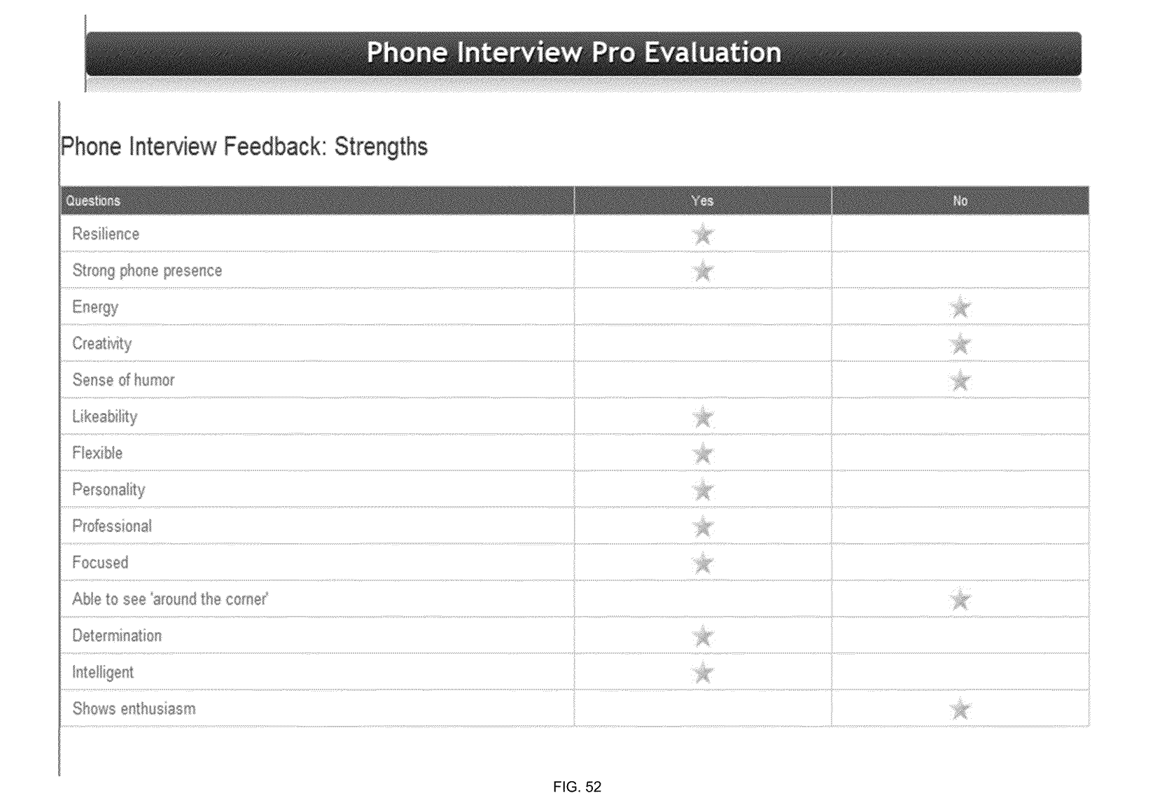

### DETAILED DESCRIPTION OF THE EMBODIMENT

The Phone Interview Pro (PIP) system and method simulates an actual telephonic interview for a job applicant. In the current embodiment, the applicant registers on a proprietary website and pays the required fee with a credit card, Paypal or other convenient method. Once the applicant has registered, he will receive a confirmation e-mail from an executive evaluator to schedule the interview. This is a “real telephone interview” although other methods maybe used such as Skype, iChat or other VoIP techniques including live video. The Evaluator is a professional with experience and training who will be asking predetermined phone interview questions. Everything the applicant says and does during the phone interview will be a component of the phone interview evaluation report.

The grading system is based on years of corporate recruiting research, human resources development, a massive database of phone interview test results, proprietary software and a phone interview rating algorithm. As the phone interview is being conducted, the Evaluator is inputting data into a proprietary computer system to determine the applicant's phone interviewing skill level.

Now referring to the attached drawings:

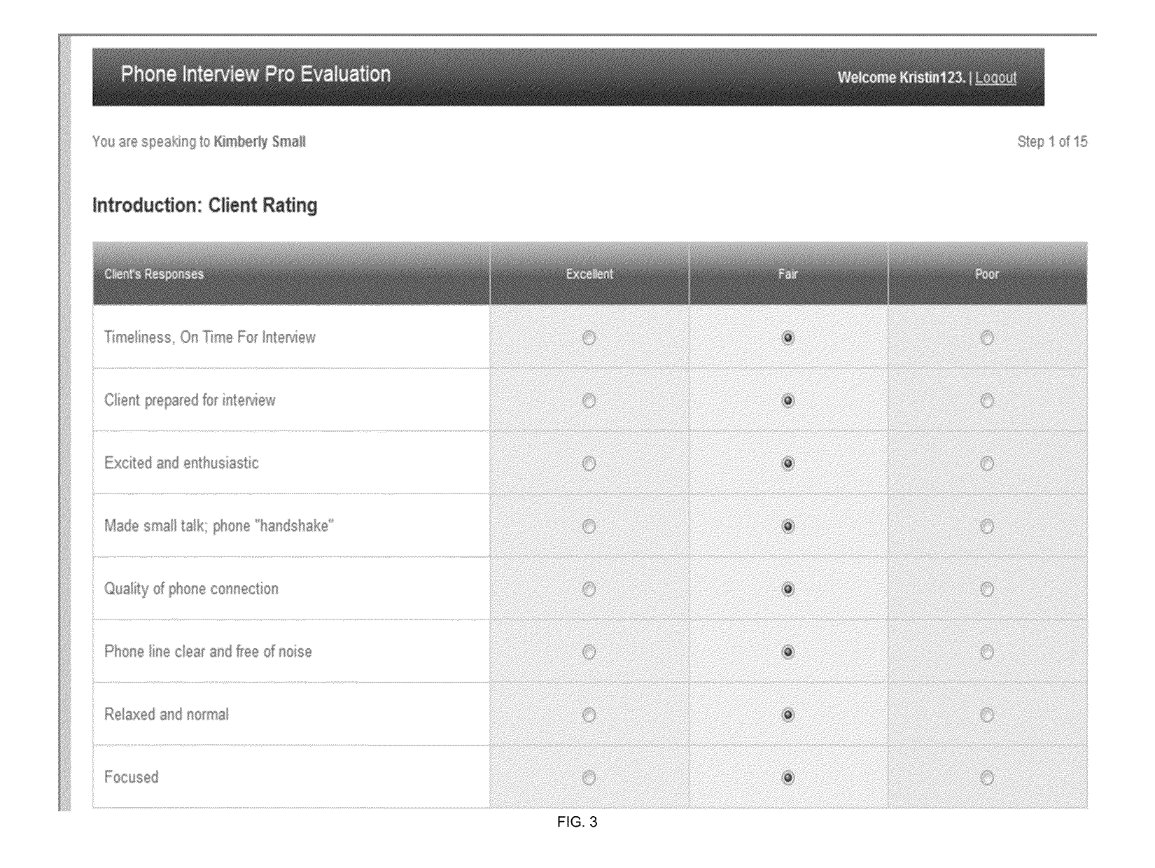

FIG. 3 shows a picture of the home page of the Phone Interview Pro website. Basic information is provided to the applicant and he can register by providing contact information and payment.

Phone Interview Pro (PIP) provides a heretofore undiscovered focus on a critical part of the job application process. While much attention has been and is paid to the look and content of a paper resume, no one has provided a method and process for evaluating a candidate's personal interviewing skill on the telephone. PIP is an invention that addresses that need.

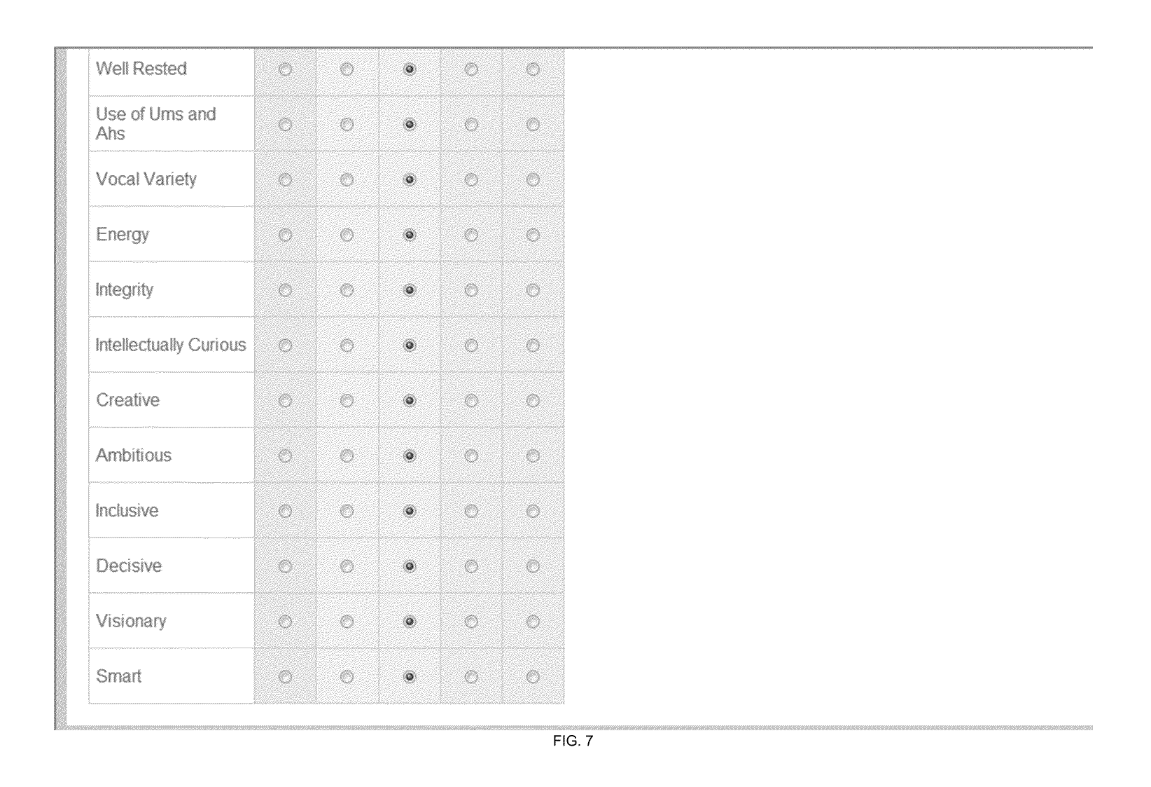

FIG. 7 shows a slide demonstrating the time line to a job offer with and without PIP. The invention improves an Applicant's personal skills so that he or she becomes much more attractive as a potential employee, thus reducing the average time to a job offer.

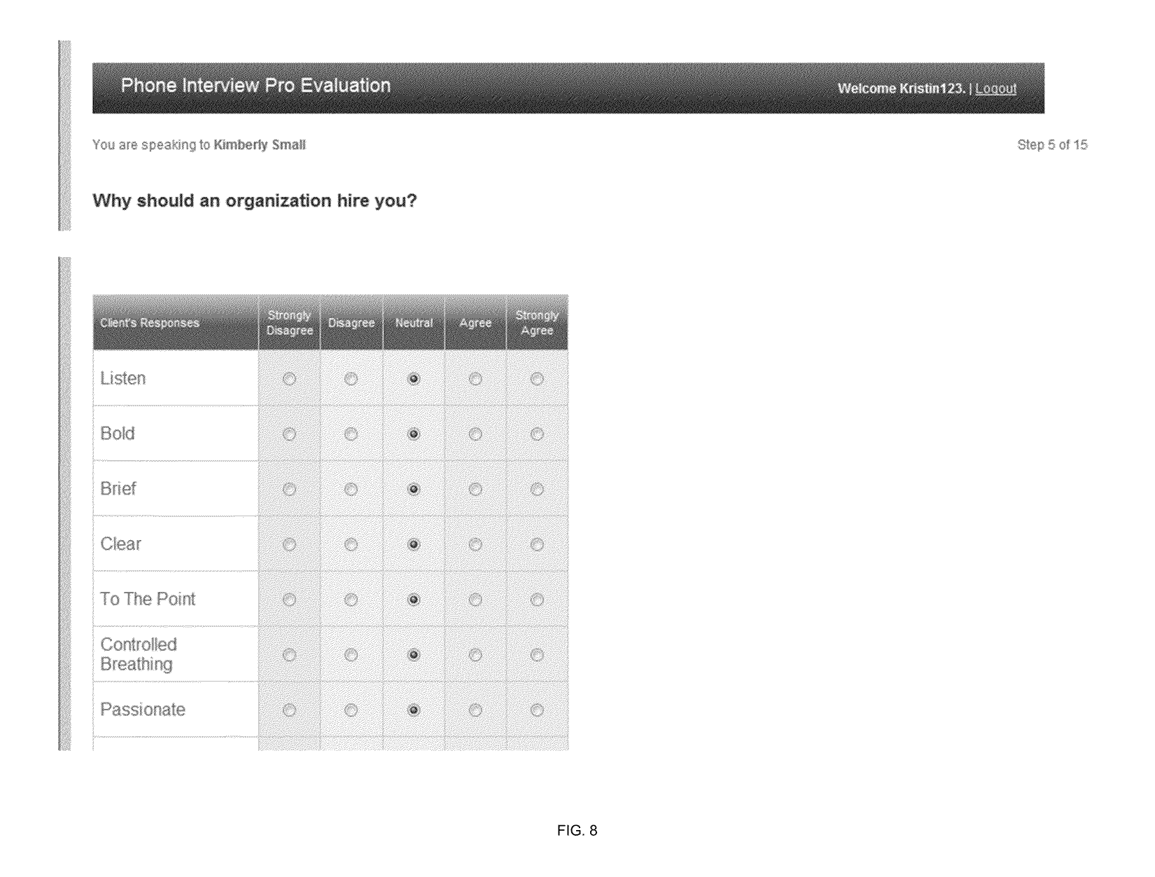

FIG. 8 is a block diagram showing the fundament components of PIP. The client contacts PIP over the Internet via a web browser. The Evaluator receives the client's information from an automatically generated email by the computer system. The Evaluator then communicates with the client via email to schedule the live phone interview at a mutually agreeable time.

At the agreed time and place the Evaluator calls the client on the telephone and conducts the interview. During the entire interview the Evaluator is asking predetermine questions and scoring the client's responses. The data is input to a computer and processed by the PIP software. The computer algorithm uses data from a historical and proprietary database to score the clients interview. The algorithm concludes by generating a report of how the client did on the interview including strengths and weaknesses along with recommendations for improvement. The report is electronically forwarded to the client. A follow up counseling session may be optionally scheduled by the client with the Evaluator.

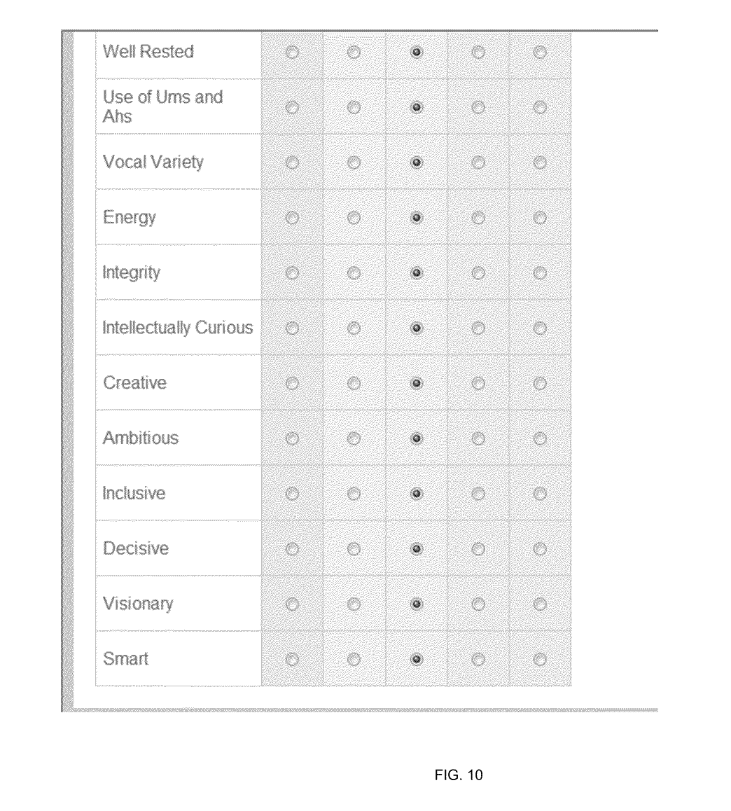

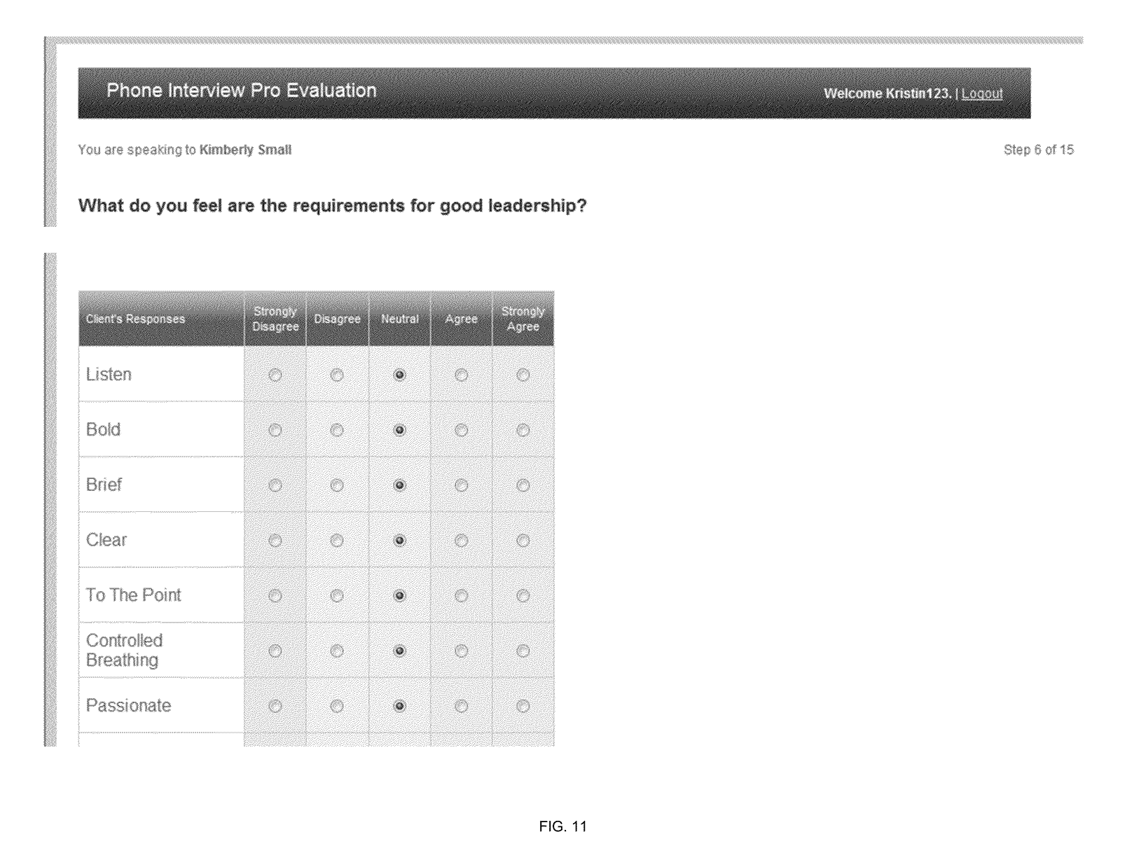

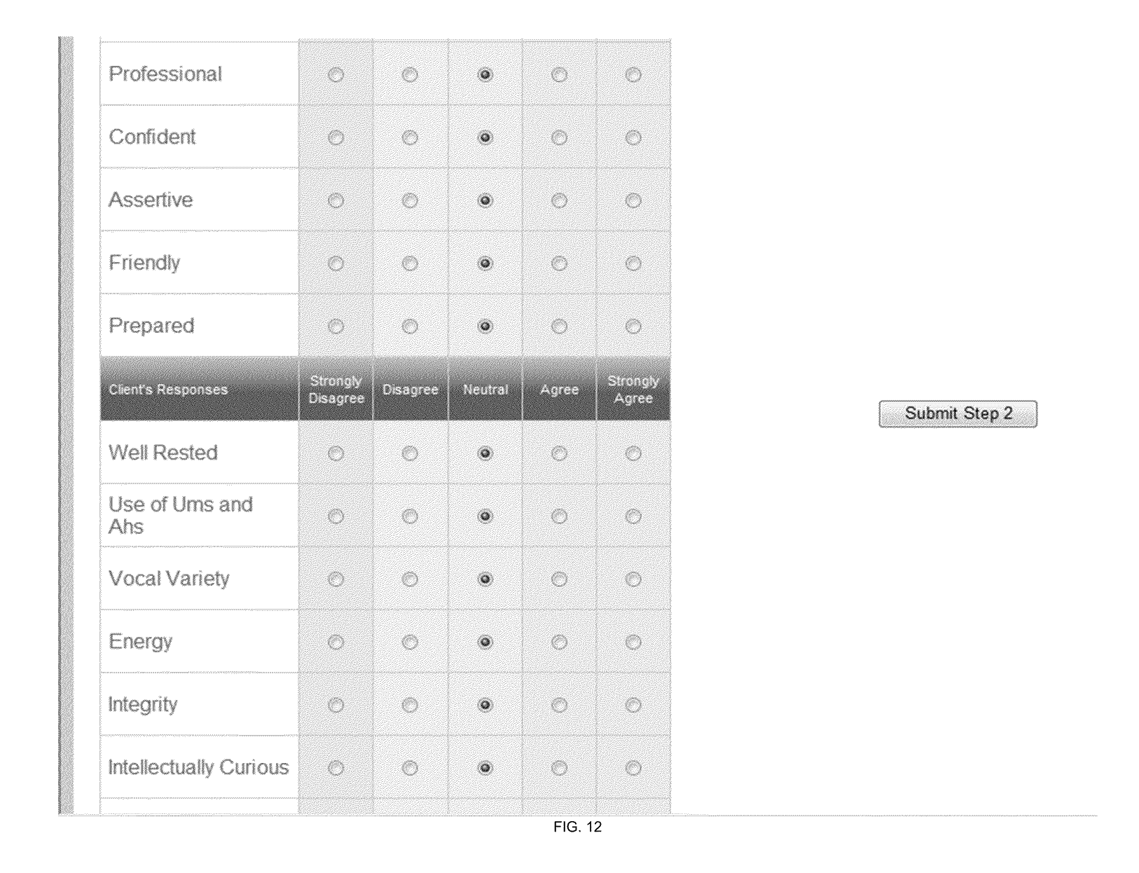

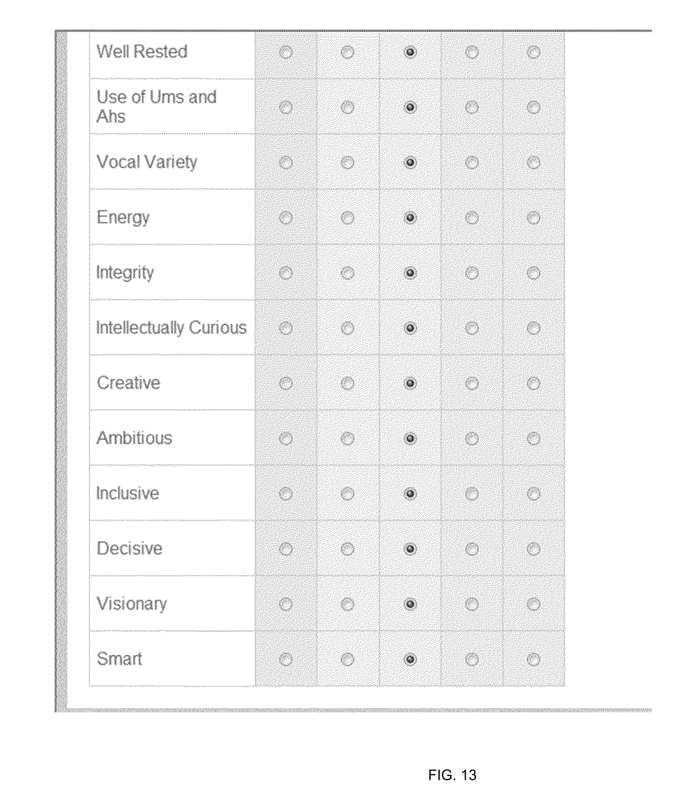

FIGS. 10-13 are screen shots of the initial information provided to the Evaluator and initial conditions of the interview such as the client's initial demeanor and environment, e.g. background noise in the room, or the quality of the phone connection.

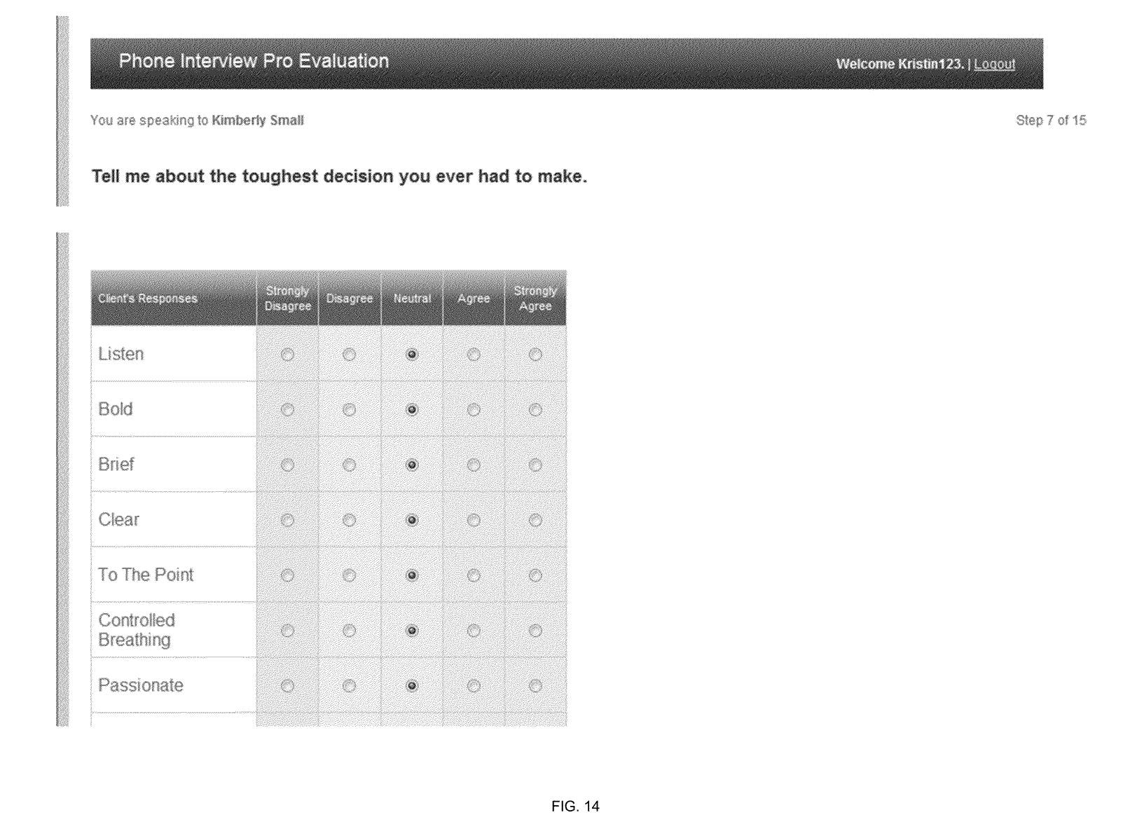

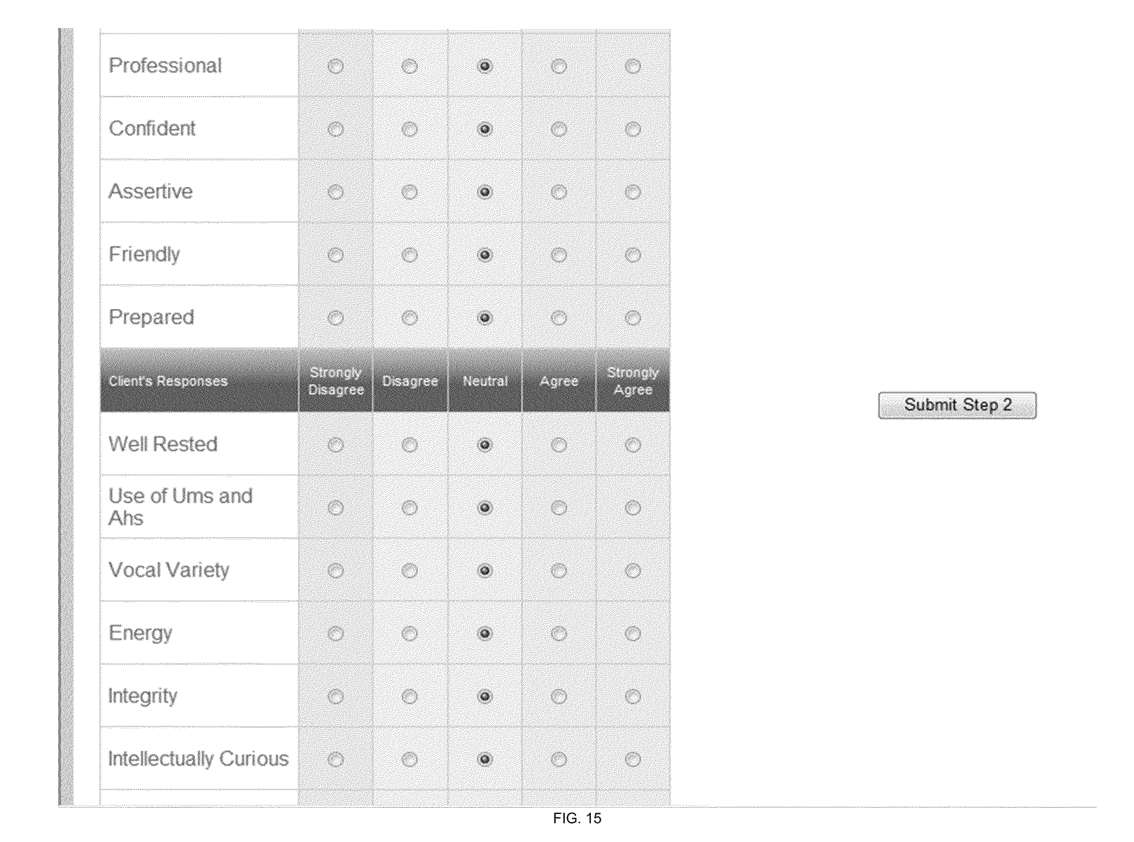

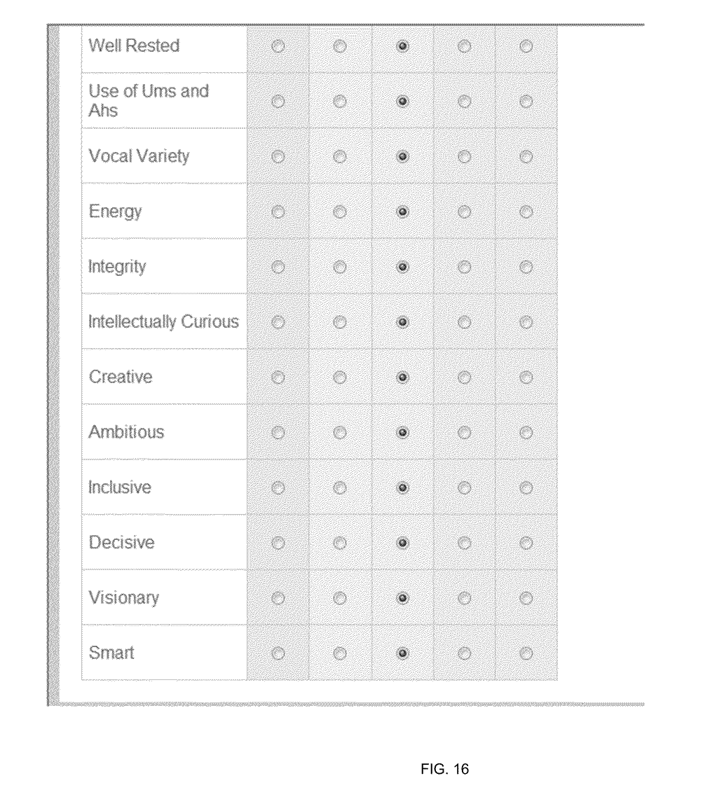

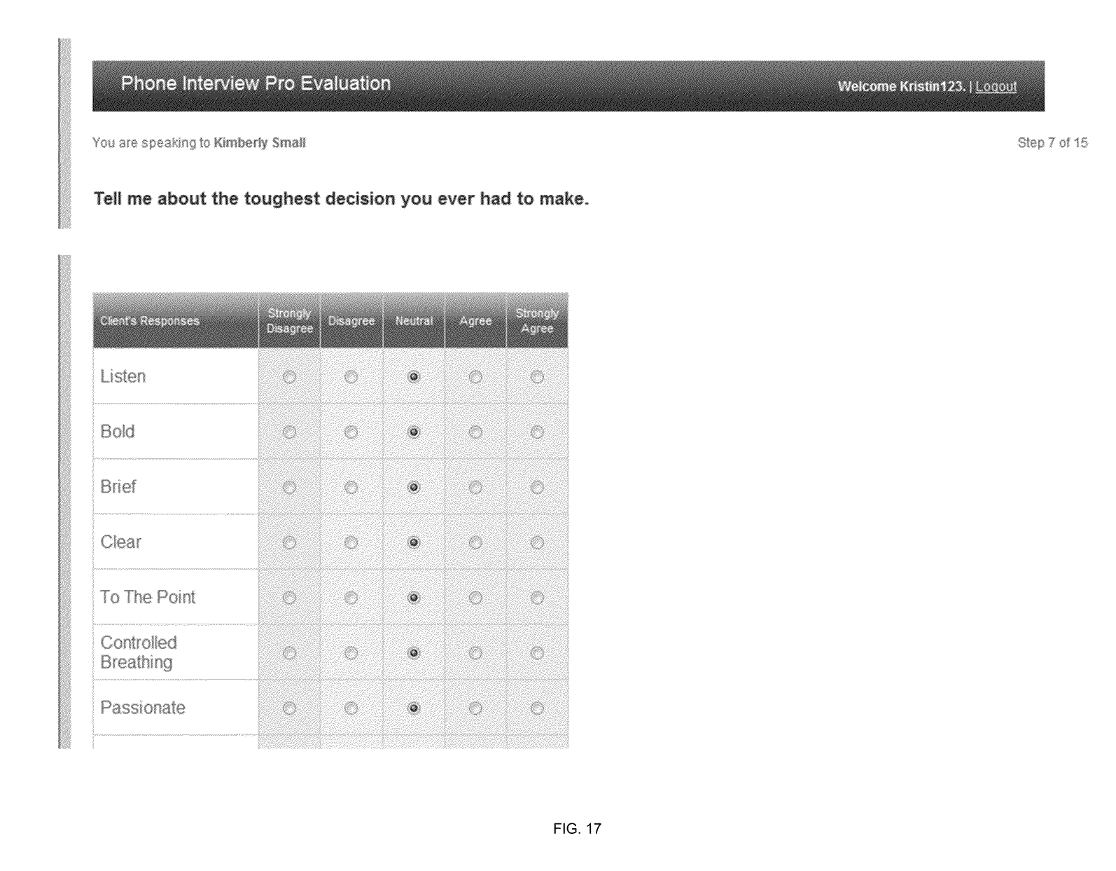

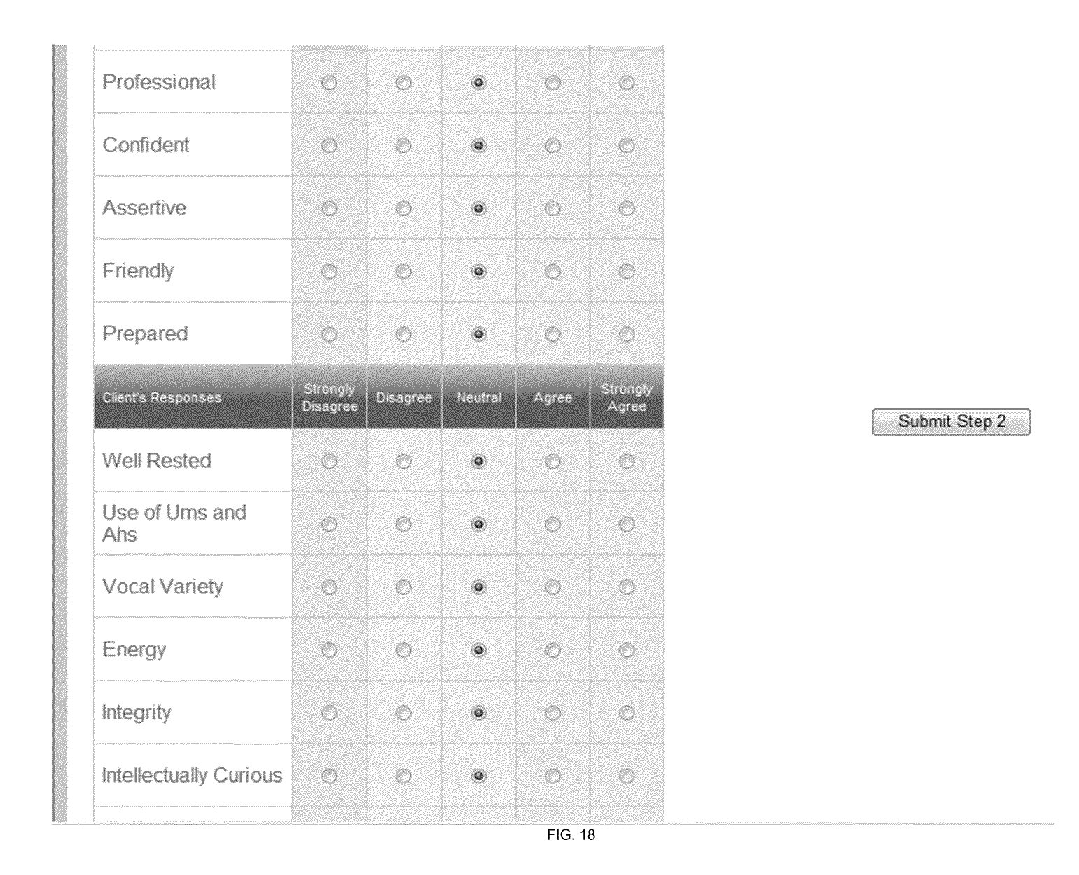

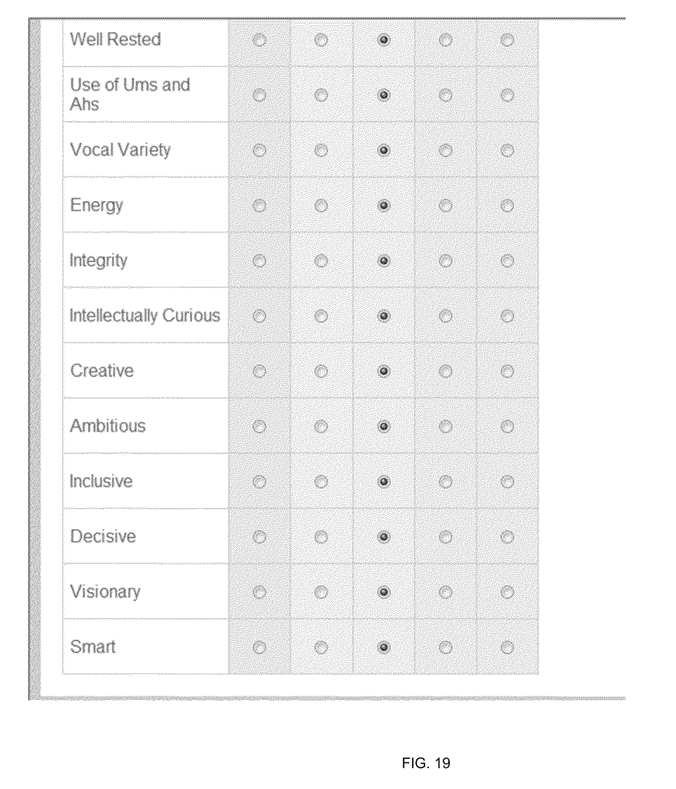

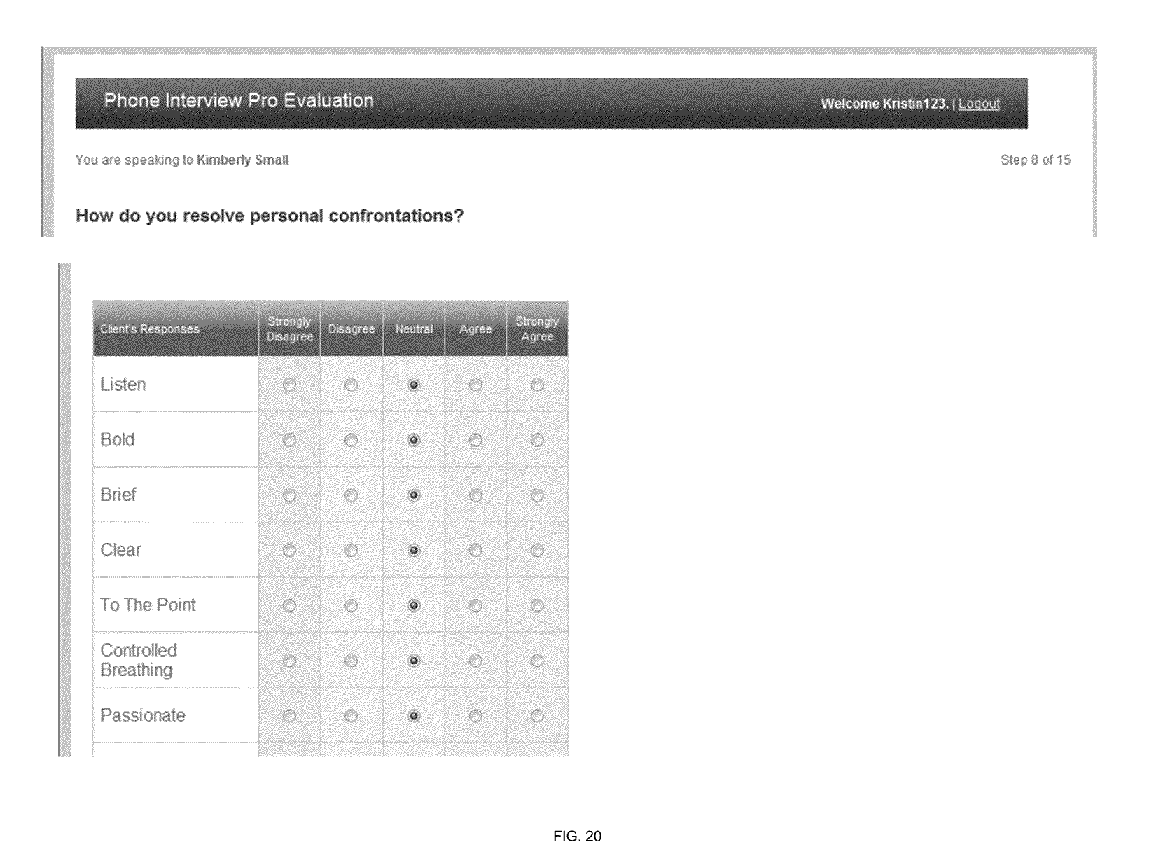

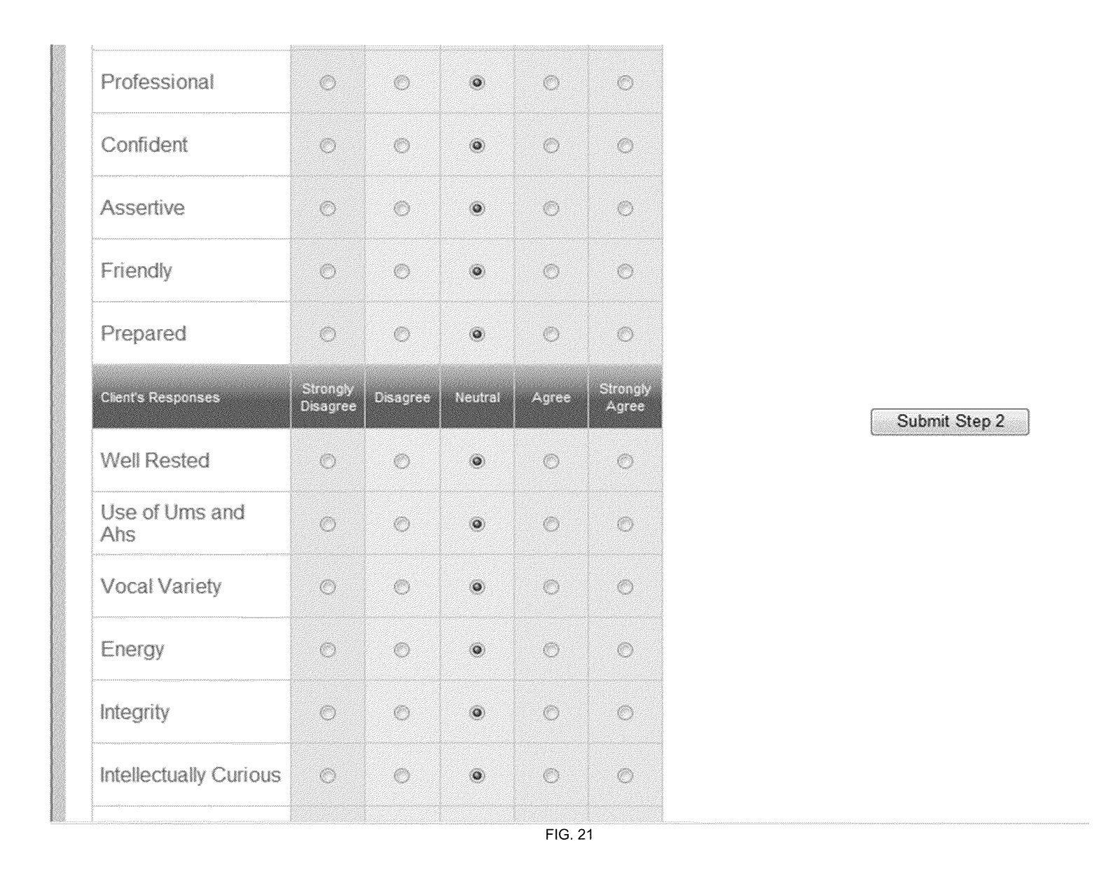

FIGS. 14-21 are screen shots of substantive questions asked by the Evaluator and a scoring chart for the Evaluator's input. Over 23 parameters are measured from speech patterns such as the use of time wasting phrases like: “umm” and audible breathing patterns to content oriented parameters such as being prepared, being assertive, or to the point. Each of these parameters is scored on a sliding scale from 0 to 100%. The parameters can be weighted evenly or varied according to certain proprietary profiles. The Evaluator may also enter notes about certain apparent factual inconsistencies in the client's responses.

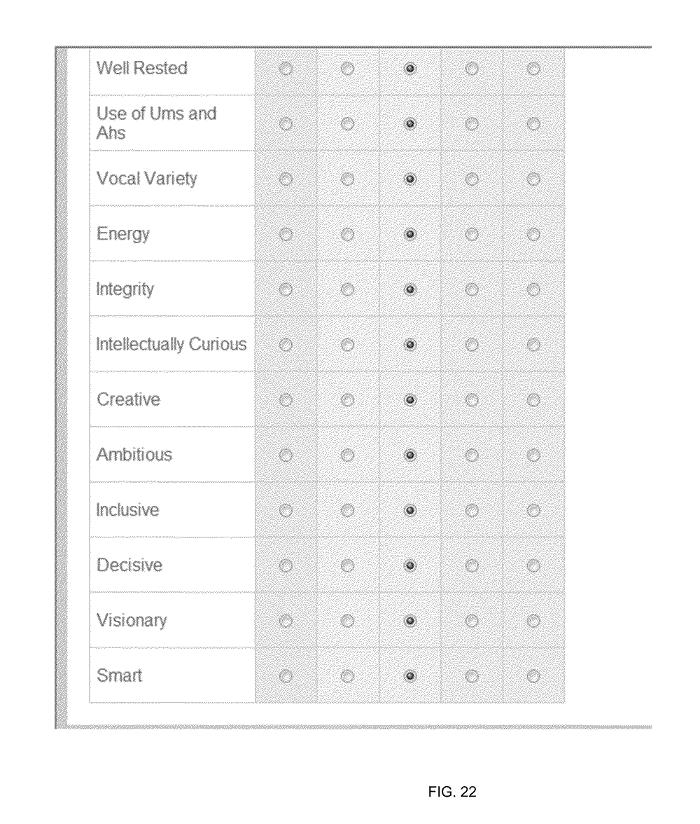

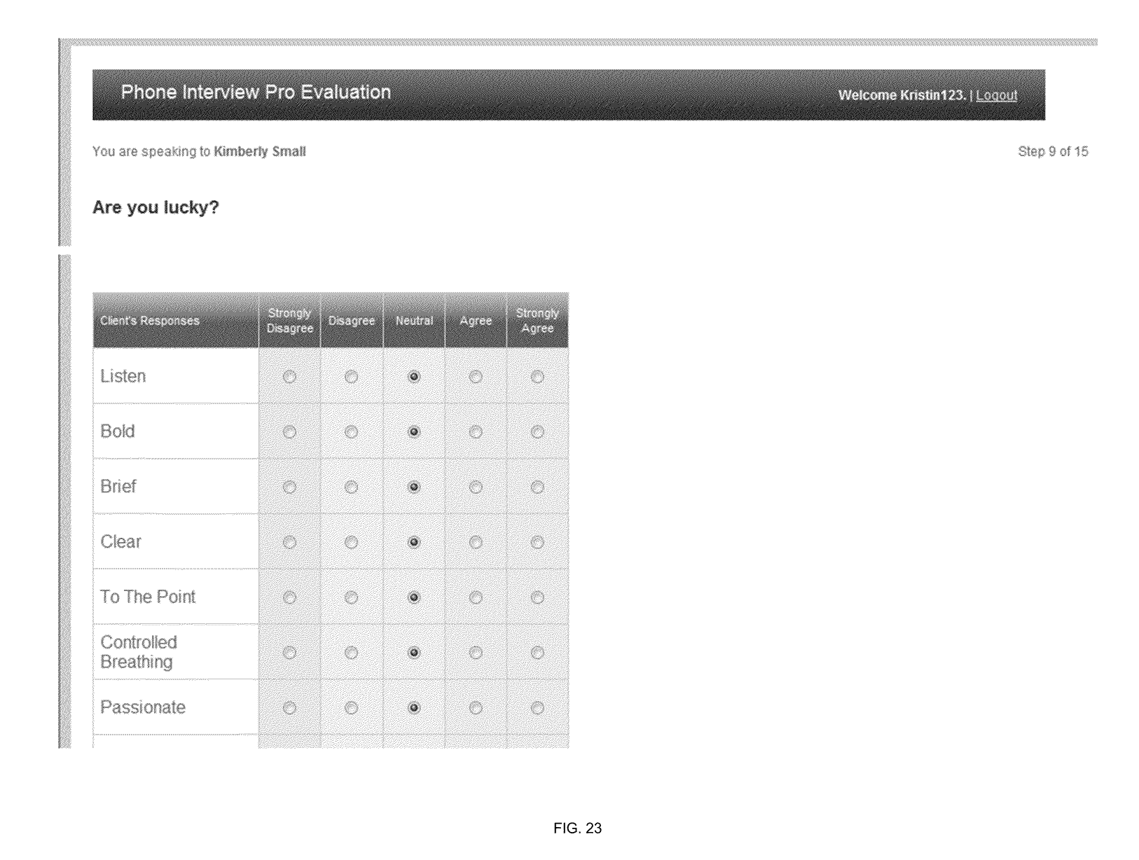

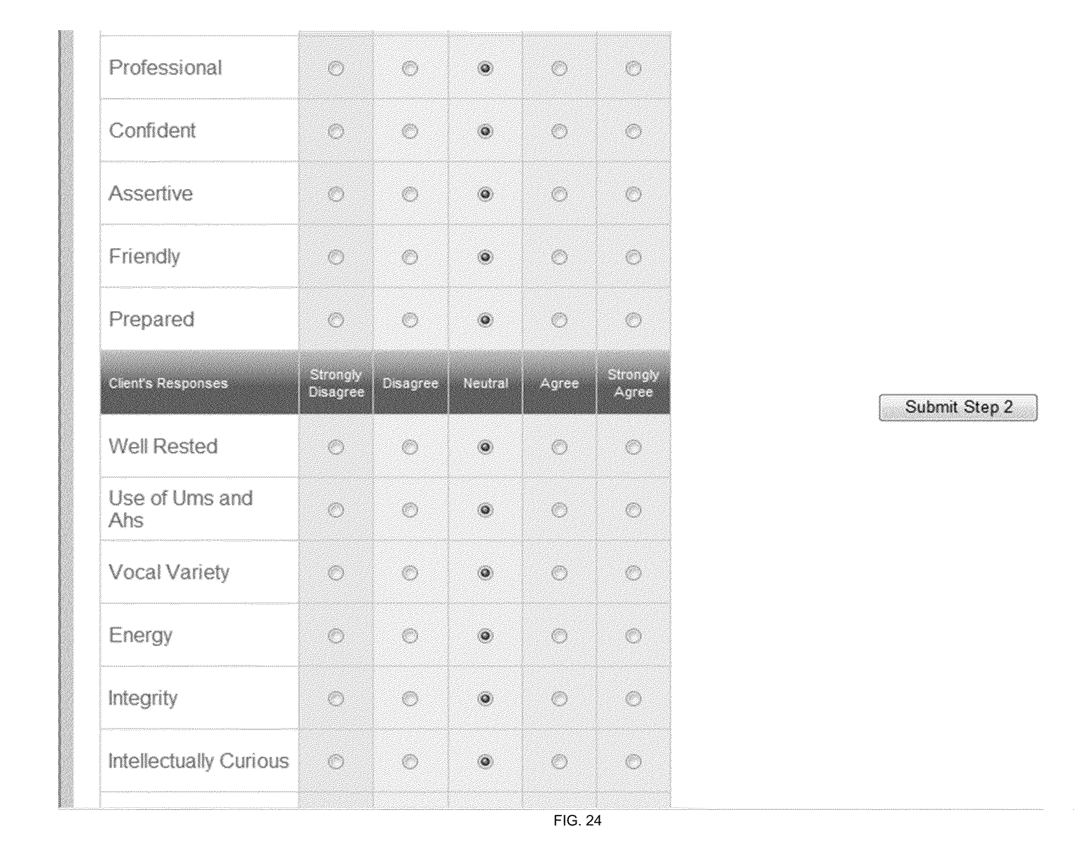

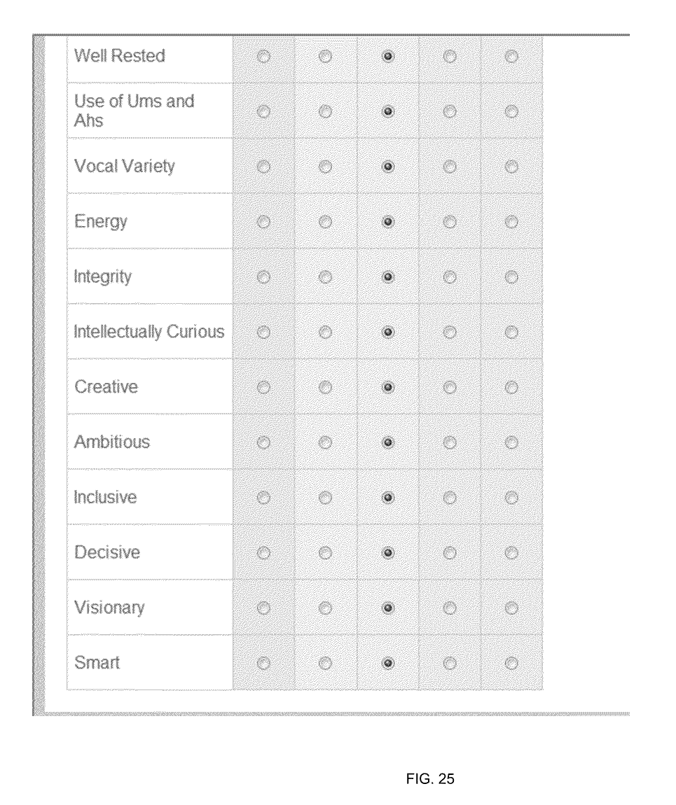

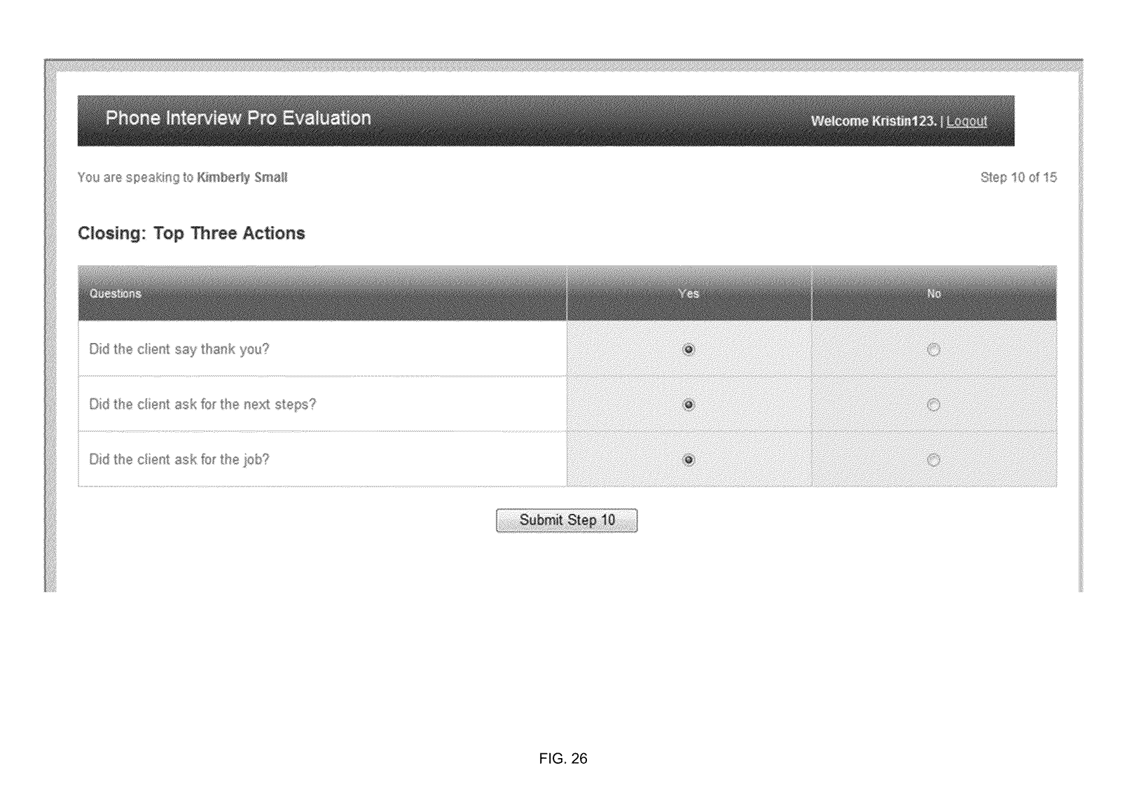

FIGS. 22-26 are screen shots for the Evaluator to input the closing parameters for the interview such as ‘asking for the job’ and some post call input such as overall human characteristics including ‘confident’, ‘professional’ and ‘on fire’. The Evaluator also inputs areas that need improvement such as being on time, using proper English, and being friendlier. An overall rating input as to how the client compares with others and an ultimate recommendation are provided for the Evaluator.

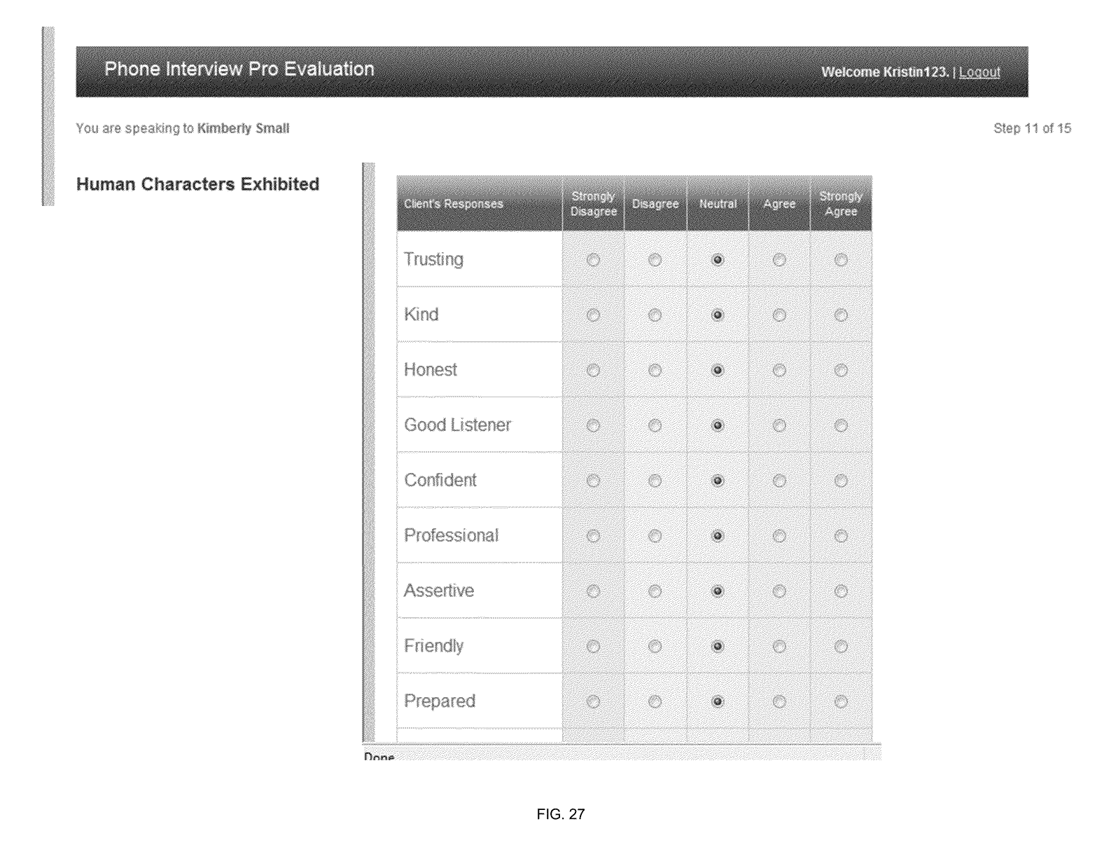

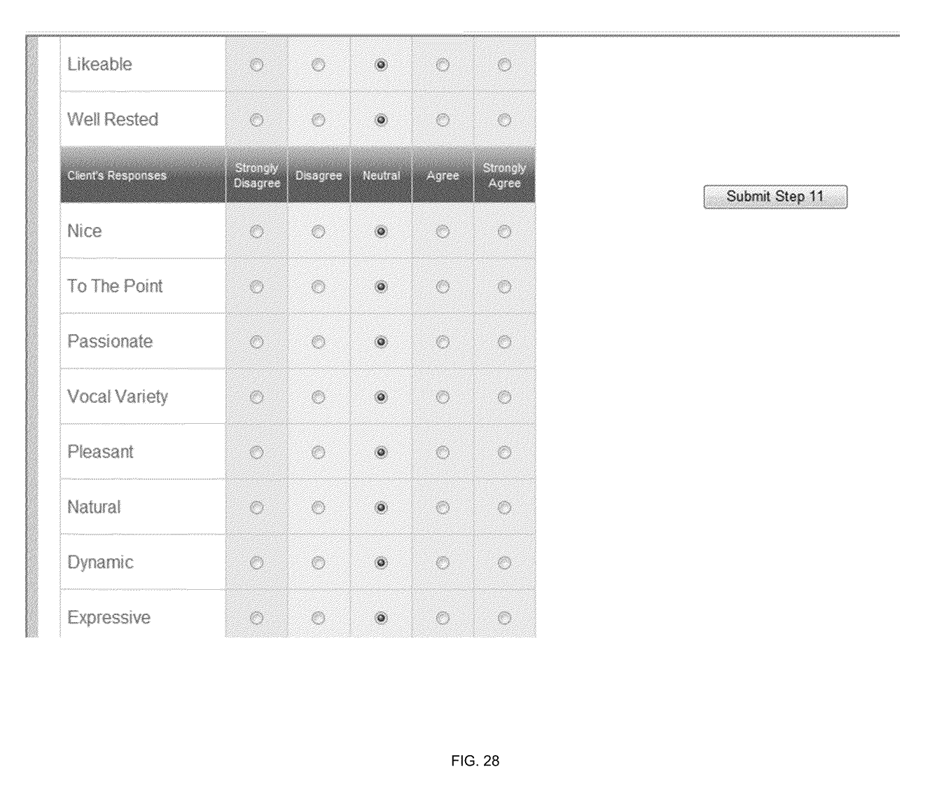

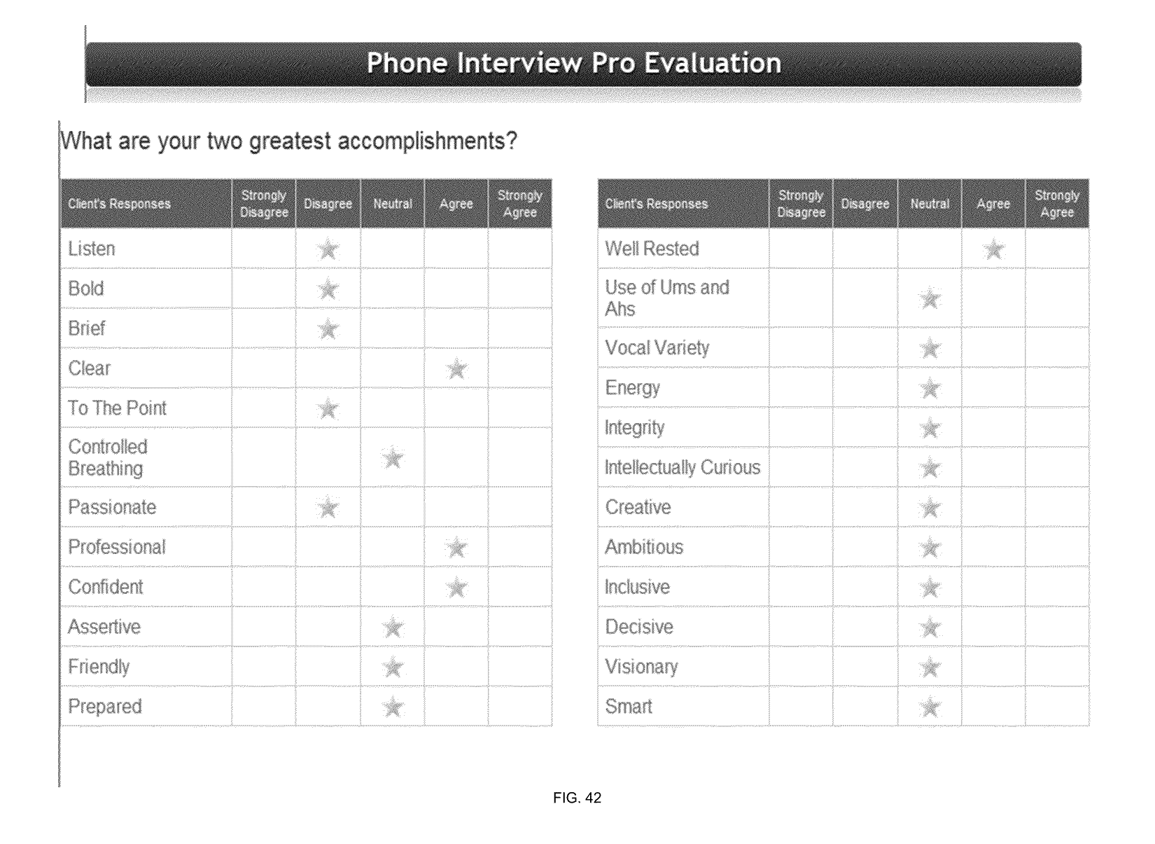

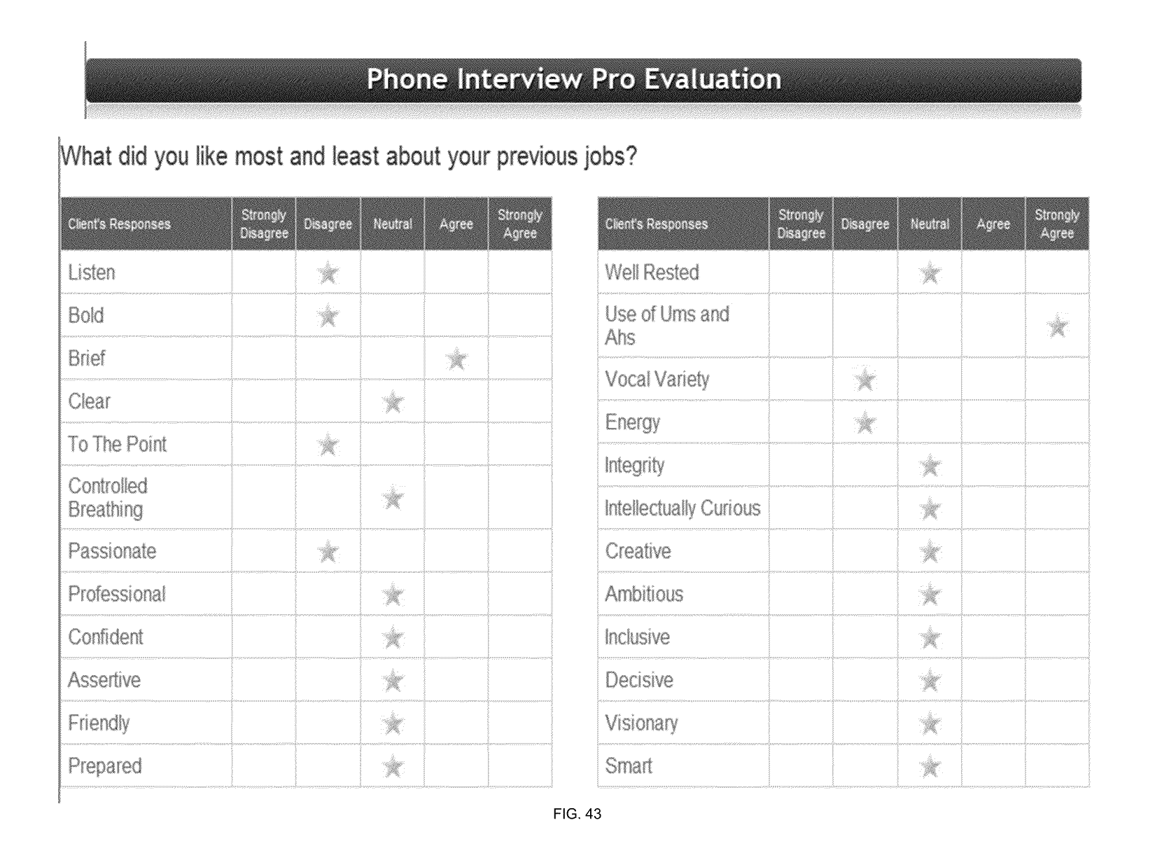

FIGS. 27, 28, 42-43 are screen shots of a report format provided to the client post interview with the Evaluator's comments on each area of concern.

The algorithm provides input for new and different questions to be tried out on a test population to determine if they would be effective as new questions in the interview program. The order of questions can be easily changed along with the weighing accorded to each question. Certain specific questions can be added to challenge the accuracy of the candidates technical knowledge.

Timing information can be measured by the Evaluator inputting time marks at the beginning of each question. This would provide information on quick or delayed responses.

The Evaluator interacts with a computer interface during the interview and post interview period to input his comments and scores. The computer architecture may be run on a variety of operating systems such as Windows, Macintosh OS X, Linux, Unix or any other common operating system. The computer program can run on a local machine or function in a client/server mode so as to process many different interviews at the same time. Computer networks may be implemented over the Internet or alternatively on VPNs. Administrator modes are used for system maintenance, updates and to oversee Evaluators availability, workload and scoring tendencies. Correction factors may be adjusted for personal characteristics of each Evaluator so as to normalize the scoring output for a pool of Applicants over time.

An optional system feature is the selection of an audio/video recording mode and playback of the actual interview. The interview is recorded in digital form on the server. This is especially easy to facilitate with VoIP through Skype or iChat. During the interview the Evaluator marks the audio/video track by keyboard or other computer input so that the interview questions can be replayed for review and discussion with the applicant. The entire digital file may also be provided or delivered to the applicant over the Internet via download or email. This mode may also be used for Evaluator training and mentoring.

Another optional mode is tailoring the interview to include information relevant to the client's resume. The applicant forwards his resume at registration time and it is process by the computer program to generate industry specific questions. Questions can be used solely to generate talking opportunities for the client or to assess technical competence.

A further mode includes a corporate setting. Certain technical questions may be included in the interview to assess important aspects of a target candidate population, for example, certain questions may be provided by a corporation seeking a new CTO.

Although this invention is tailored towards job applicants, the techniques and algorithms may be used in other interviewing settings such as collecting political view during an elections campaign or gauging a community reaction to certain events including for example a natural disaster or national tragedy.

1. I claim a telephone interview evaluation system comprising:
a computer serving a website on the internet for a customer to register and pay for a telephone interview evaluation;
a system operator to receive said registration and communicate with said customer to set a date and time certain for a telephone interview;
a evaluator who places a telephone call to the customer at the said date and time;
a series of predetermined questions asked by the evaluator to the customer;
a score sheet on which the evaluator rates and records the performance of the customer;
a software program for processing said score sheet into an electronic report; and
said evaluator forwarding said report to said customer for review.
